(19) United States
(12) Patent Application Publication
(10) Pub. No.: US 2025/0137317 A1
(43) Pub. Date: May 1, 2025

(54) AUTOMATED SYSTEM AND METHOD FOR GAS FILLING AND PATCHING OF GLASS PANELS

(71) Applicant: Integrated Automation Systems, LLC, Bedford Heights, OH (US)

(72) Inventors: Michael E. PETERS, Ravenna, OH (US); Wesley SCOTT, Rootstown, OH (US); Michael P. MCHUGH, Solon, OH (US); Ryan M. MCHUGH, Hudson, OH (US); Joseph A. MORENO, Galena, OH (US)

(73) Assignee: Integrated Automation Systems, LLC, Bedford Heights, OH (US)

(21) Appl. No.: 18/923,018

(22) Filed: Oct. 22, 2024

Related U.S. Application Data
(60) Provisional application No. 63/593,015, filed on Oct. 25, 2023.

(51) Int. Cl. E06B 3/673; B65G 49/06; E06B 3/677

(52) U.S. Cl. CPC E06B 3/67365; B65G 49/061; B65G 49/063; E06B 3/6775

(57) ABSTRACT

Automated production systems and associated methods for automated gas filling and patching of glass panels (e.g., insulating glass units). The system includes a rack for transporting a plurality of glass panels, a rack indexer assembly for moving the rack along a travel path, and a glass panel fabricating system having an industrial robot with end-of-arm tools for gas filling and patching of glass panels.

### FIELD OF THE INVENTION

The present invention relates generally to the fabrication of glass panels, and more particularly to an automated system and method for filling and patching glass panels, including the loading and unloading of glass panels onto/from a transportable rack, said glass panels including, but not limited to, insulating glass units (IGU), laminated glass units, glass composites, monolithic glass, and the like.

### BACKGROUND OF THE INVENTION

In the process of fabricating glass panels, there is a continuing need for greater production efficiency, reductions in production costs and material waste, and improvements in product quality and worker safety. The apparatus and methods of the present invention addresses these and other industry needs.

### SUMMARY OF THE INVENTION

In accordance with the present invention, there is provided an automated system for gas filling and/or patching of glass panels, including the loading/unloading of glass panels and the like onto/from a transportable rack.

In accordance with another aspect of the present invention, there is provided a method for automated gas filling and/or patching of glass panels, including the loading/unloading of glass panels and the like onto/from a transportable rack.

In accordance with yet another aspect of the present invention, there is provided an automated production system for glass panels, said system comprising: (a) a rack indexer assembly including a pop-up roller assembly having a roller unit comprised of a plurality of motor-driven rollers, said roller unit movable between a lowered position and a raised position, wherein in the raised position, the plurality of rollers of the roller unit align linearly along a horizontal axis with the plurality of rollers of the support frame; (b) a glass panel fabricating system including an industrial robot system for gas filling and/or patching of glass panels; and (c) a control unit for controlling operation of the glass panel fabricating system and movement of the roller unit between the lowered and raised positions.

According to another aspect of the present invention, there is provided a method for producing glass panels, comprising the steps of: loading a plurality of glass panels onto a rack; moving the rack along a travel path to a first position using an automated rack indexing assembly, said travel path associated with the processing equipment for a glass panel production line; extending a first glass panel outward from the rack for processing; retracting the first glass panel into the racking after processing; moving the rack along the travel path to a second position using the automated rack indexing assembly; and extending a second glass panel outward from the rack for processing; and retracting the second glass panel into the racking after processing.

According to yet another aspect of the present invention, there is provided a gas filling and patching system for processing glass panels, comprising: a gas filling unit having one or more gas filling stations for filling glass panels with gas; a patching unit having one or more patching stations for patching glass panels filled with gas; a loading shuttle for conveying a glass panel to the gas filling unit; and an unloading shuttle for unloading the glass panel filled with gas from the gas filling unit and conveying the glass panel to the patching unit.

According to still another aspect of the present invention, there is provided a method for gas filling and patching of glass panels, the method comprising the steps of: conveying a glass panel to a loading shuttle; moving the loading shuttle to align and transfer the glass panel to a gas filling unit, said gas filling unit having one or more gas filling stations, each gas filling station having a slot for receiving a glass panel; moving the loading shuttle to continue loading glass panels into empty slots of the gas filling unit; simultaneously and independently filling each glass panel in the slots of the gas filling stations with gas; after a gas filling operation is completed for a glass panel, conveying the glass panel from the slot of the gas filling station to unloading shuttle; conveying the glass panel from the unloading shuttle to a patching unit for pathing the glass panel; and transferring the patched glass panel out of the patching unit.

An advantage of the present invention is the provision of an automated system and method for gas filling and patching of glass panels that reduces the amount of manual labor required for glass panel fabrication.

Another advantage of the present invention is the provision of an automated system and method for gas filling and patching of glass panels that increases glass panel production speed.

Another advantage of the present invention is the provision of an automated system and method for gas filling and patching of glass panels that is adaptable to fill multiple glass panels simultaneously.

Another advantage of the present invention is the provision of an automated system and method for gas filling and patching of glass panels that is adaptable to patch multiple glass panels simultaneously.

Another advantage of the present invention is the provision of an automated system and method for gas filling and patching of glass panels that improves quality through greater consistency in the fabrication of glass panels.

Another advantage of the present invention is the provision of a system and method for gas filling and patching of glass panels that is adaptable to handle glass panels of various dimensions.

Another advantage of the present invention is the provision of a system and method for gas filling and patching of glass panels that includes automatic loading and unloading of racks.

Another advantage of the present invention is the provision of a system and method for gas filling and patching of glass panels that automatically indexes the position of a rack to allow continuous processing.

Still another advantage of the present invention is the provision of a system and method for gas filling and patching of glass panels that reduces operator handling of the glass panels.

These and other advantages will become apparent from the following description of illustrated embodiments taken together with the accompanying drawings and the appended claims.

### BRIEF DESCRIPTION OF THE DRAWINGS

The invention may take physical form in certain parts and arrangement of parts, embodiments of which will be described in detail in the specification and illustrated in the accompanying drawings which form a part hereof, and wherein:

FIG. 1 is a perspective view of a rack according to an embodiment of the present invention;

FIG. 2 is a front plan view of the rack shown in FIG. 1;

FIG. 2A shows a base frame front support according to an alternative embodiment;

FIG. 3 is a perspective view of a manual conveyance system for a manual racking system, according to an embodiment of the present invention, said conveyance system including a vertical conveyor, a pop-up roller assembly, and a floor track assembly;

FIG. 4 is a front plan view of the conveyance system shown in FIG. 3;

FIG. 5 is a side plan view of the conveyance system shown in FIG. 3;

FIG. 6 is a top plan view of the conveyance system shown in FIG. 3;

FIG. 7 is a perspective view of the vertical conveyor shown in FIG. 3;

FIG. 8 is a perspective view of an indexing unit of the manual conveyance system shown in FIG. 3;

FIGS. 8A-8B illustrate operation of the indexing unit of FIG. 8 to index a rack with the manual conveyance system of FIG. 3;

FIG. 9 is a perspective view of the manual racking system including the manual conveyance system shown in FIGS. 3-6 and the rack shown in FIGS. 1 and 2;

FIG. 10 is an enlarged view of a portion of the manual racking system shown in FIG. 9;

FIG. 11 is a side plan view of the manual racking system shown in FIG. 9;

FIG. 12 is a front plan view of the manual racking system shown in FIG. 9;

FIG. 13 is a top plan view of the manual racking system shown in FIG. 9;

FIG. 14 is a perspective view of an indexing unit according to an alternative embodiment;

FIGS. 14A-14C illustrate operation of the indexing unit of FIG. 14 to index a rack to the manual conveyance system and to advance the rack to a new slot position;

FIG. 15 is a front perspective view of a vertical tilt conveyor of an automated conveyance system for an automated racking system, according to an embodiment of the present invention;

FIG. 16 is a rear perspective view of the vertical tilt conveyor shown in FIG. 15;

FIG. 17 is an enlarged view of a motorized drive belt system of the vertical tilt conveyor shown in FIG. 16;

FIG. 18 is a perspective view of a rack indexer assembly of the automated conveyance system for the automated racking system, according to an embodiment of the present invention;

FIG. 19 is a top plan view of the rack indexer assembly shown in FIG. 18;

FIG. 20 is a side plan view of the rack indexer assembly shown in FIG. 18;

FIG. 21 is a front plan view of a pop-up roller assembly of the rack indexer assembly shown in FIGS. 18-20;

FIG. 22 is an enlarged front perspective view of a portion of the rack indexer assembly including the pop-up roller assembly;

FIG. 23 is an enlarged rear perspective view of a portion of the rack indexer assembly including the pop-up roller assembly;

FIG. 24 is a perspective view of the automated racking system, including the conveyance system comprised of the vertical tilt conveyor, the rack indexer assembly, and the rack shown in FIGS. 1-2;

FIG. 25 is an enlarged view of a portion of the automated racking system shown in FIG. 24;

FIG. 26 is a side plan view of the automated racking system shown in FIG. 24;

FIG. 27 is an overhead view of an automated production system for filling and/or patching gas panels, according to an embodiment of the present invention;

FIG. 28 is a front plan view of the automated production system shown in FIG. 27;

FIG. 29 is a side plan view of the automated production system shown in FIG. 27;

FIG. 30 is a perspective view of an industrial robot assembly and roller guide assembly according to an embodiment of the present invention;

FIGS. 31-34 illustrate industrial robot end-of-arm tooling (EOAT) according to an embodiment of the present invention, the EOAT including a gripper tool in the form of a pneumatic clamp and a process tool in the form of a dispensing nozzle block;

FIG. 35 is an overhead block diagram of an inline gas filling and patching system according to an embodiment of the present invention;

FIG. 36 is a perspective view of the inline gas filling and patching system of FIG. 35;

FIG. 37 is a side view of a gas filling unit of the system shown in FIG. 37, according to an embodiment of the present invention, said gas filling unit having a plurality of gas filling stations;

FIG. 38 is a partial view of the gas filling stations shown in FIG. 37; and

FIG. 39 is an enlarged view of gas filling heads of the gas filling stations shown in FIG. 38.

### DETAILED DESCRIPTION OF THE INVENTION

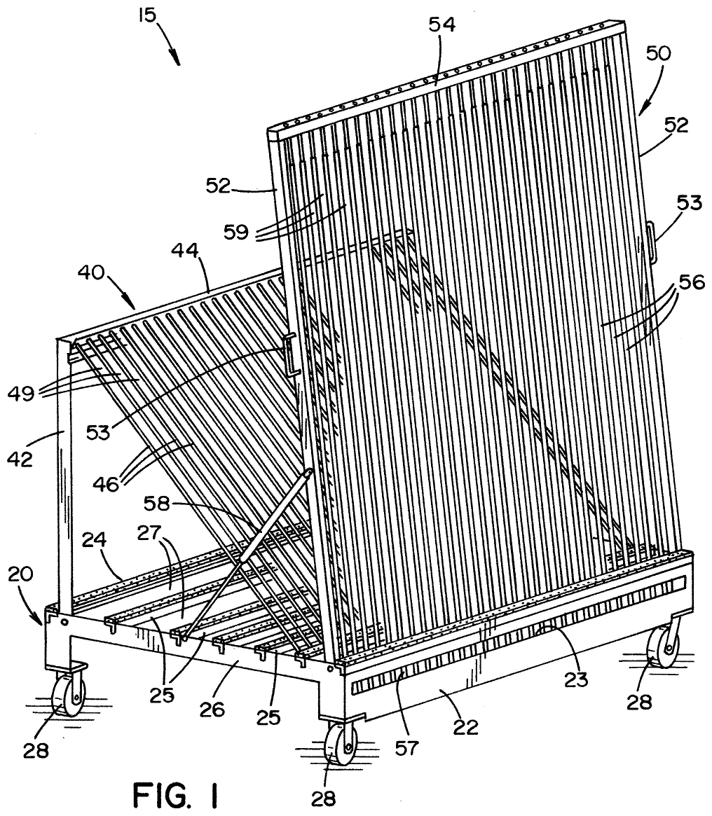

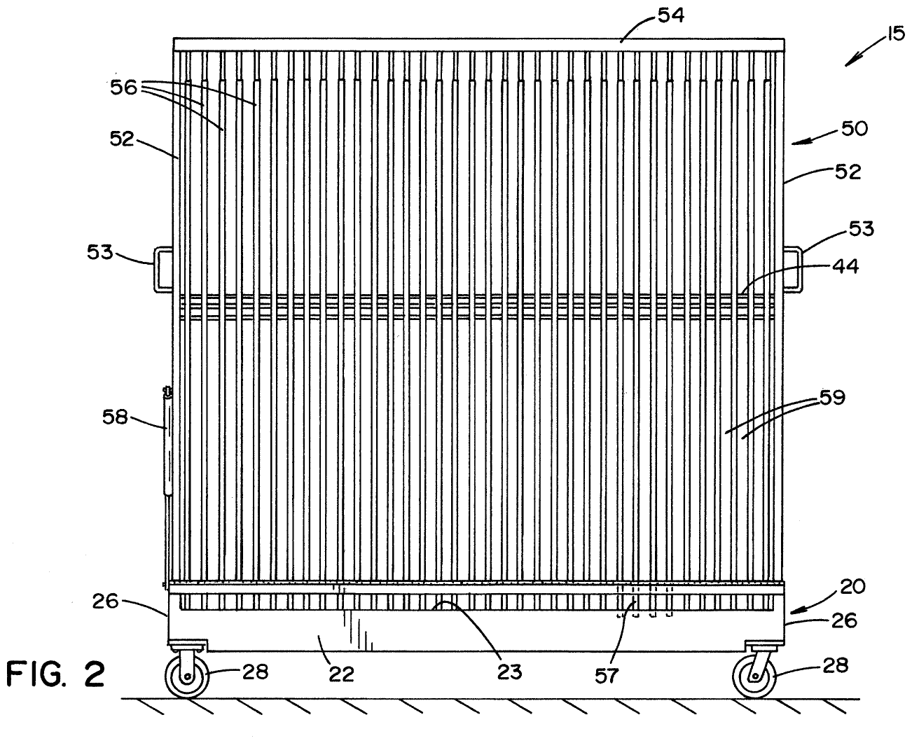

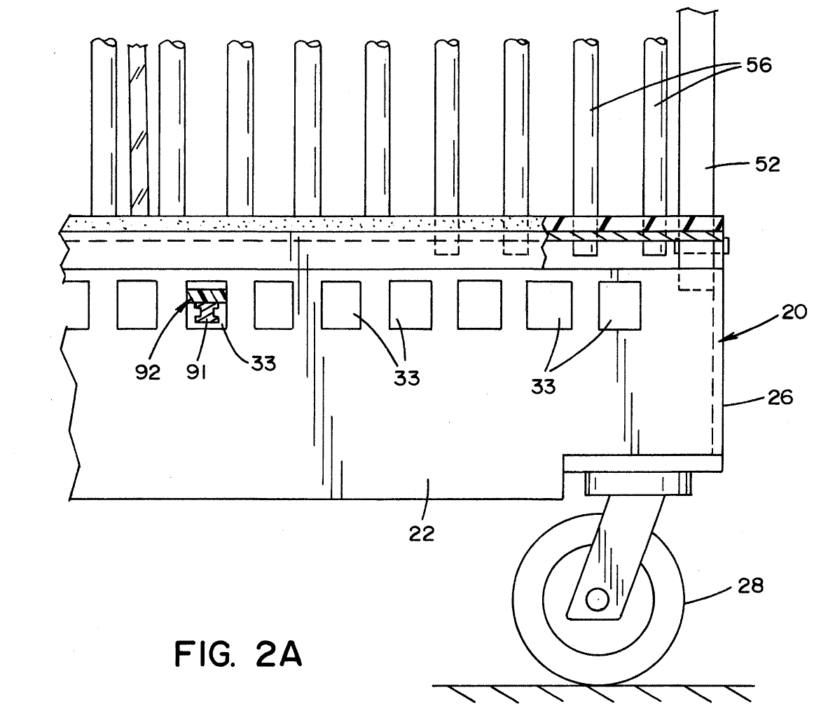

Referring now to the drawings wherein the showings are for the purposes of illustrating embodiments of the invention only and not for the purposes of limiting same, FIGS. 1 and 2 illustrate a rack 15 according to an embodiment of the present invention. Rack 15 is used with the manual and automated racking systems described herein. In the illustrated embodiment, rack 15 takes the form of a harp rack. Rack 15 may also take the form of a slat rack or the like.

Rack 15 is generally comprised of a base frame 20, a fixed rack member 40 mounted to base frame 20, and a pivoting rack member 50 mounted to base frame 20. Base frame 20 includes a front support 22 having an aperture 23, a rear support 24, a pair of side supports 26, and a plurality of spaced-apart cross supports 25 extending between side supports 26. The top surfaces of cross supports 25 preferably have a protective layer formed thereon. For example, the protective layer may take the form of a thin foam padding or the like. Openings 27 are provided in base frame 20 between adjacent cross supports 25, and between cross supports 25 and front and rear supports 22, 24. Wheels 28 are mounted at the corners of base frame 20. In the illustrated embodiment, wheels 28 are caster wheels. In accordance with an alternative embodiment of rack 15, aperture 23 of front support 22 is replaced with a plurality of spaced openings 33, as shown in FIG. 2A.

Fixed rack member 40 includes a pair of vertical posts 42 and a horizontal bar 44 extending between the top ends of vertical posts 42. Fixed rack member 40 also includes a plurality of spaced-apart rods 46 extending between horizontal bar 44 and a cross support 25, at an angle of approximately 45° relative to side supports 26. Rods 46 preferably have a protective plastic coating. Rods 46 are spaced from each other at a distance suitable for receiving glass panels of a desired dimension between a pair of rods 46. The spaces between rods 46 are referred to herein as slots. Accordingly, rods 46 define a plurality of slots 49 therebetween.

Pivoting rack member 50 includes a pair of vertical posts 52, an upper horizontal bar 54 and a lower horizontal bar (not shown). In the illustrated embodiment, each vertical post 52 has a handle 53. Pivoting rack member 50 also includes a plurality of spaced-apart rods 56 extending between upper horizontal bar 54 and the lower horizontal bar. Rods 56 preferably have a protective plastic coating. Rods 56 are spaced from each other at a distance suitable for receiving glass panels of a desired dimension between a pair of rods 56. The spaces between rods 56 are referred to herein as slots. Accordingly, rods 56 define a plurality of slots 59 therebetween. Rods 56 are spaced apart to align with rods 46 of fixed rack member 40. As a result, slots 59 of pivoting rack member 50 are aligned in correspondence with slots 49 of fixed rack member 40. In the illustrated embodiment, lower end portions 57 of rods 56 are visible and physically accessible through opening 23 of front support 22, as best seen in FIG. 2.

The lower end of pivoting rack member 50 is pivotally attached to side supports 26 of base frame 20, thereby allowing pivoting rack member 50 to move relative to fixed rack member 40. A telescoping extension arm 58 connects one of the vertical posts 52 of pivoting rack member 50 to the adjacent side support 26. Extension arm 58 supports pivoting rack member 50 in an upright position as shown in FIG. 1, and allows pivoting rack member 50 to be manually movable to a collapsed position wherein rods 56 of pivoting rack member 50 are positioned substantially parallel to rods 46 of fixed rack member 40.

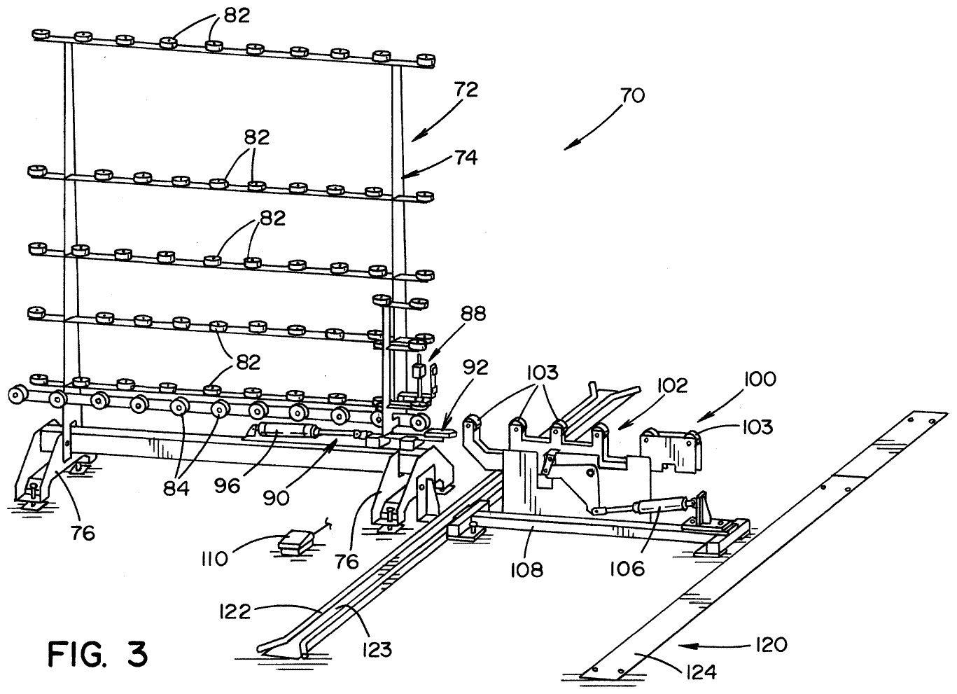

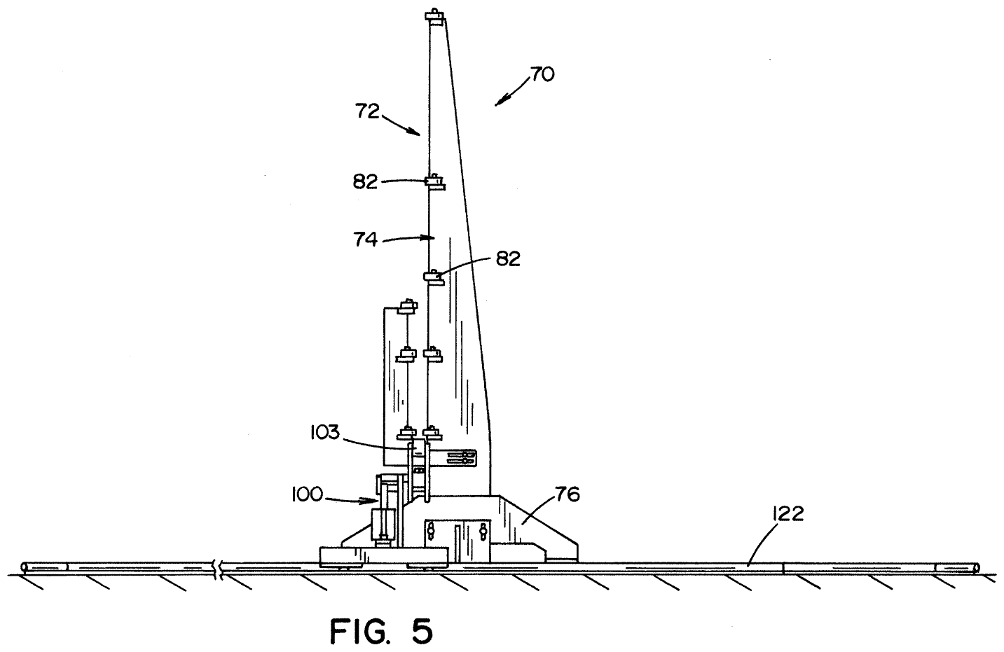

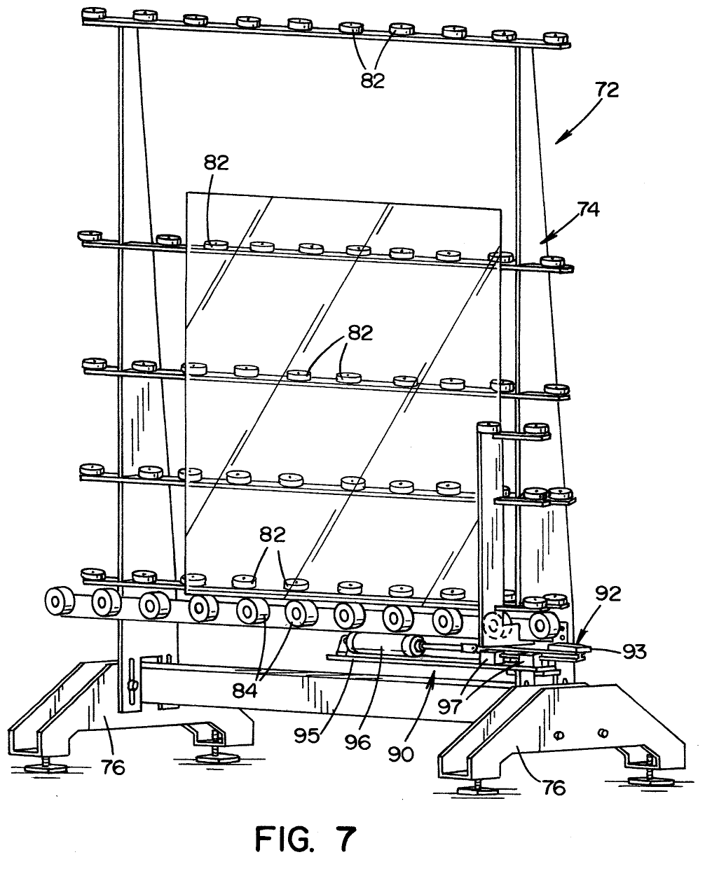

Referring now to FIGS. 3-8, a manual conveyance system 70 will be described. Manual conveyance system 70 is generally comprised of a vertical conveyor 72, a laser guide 88, an indexing unit 90, a pop-up roller assembly 100, and a floor track assembly 120.

Vertical conveyor 72 includes a support frame 74 and legs 76. Vertical rollers 82 and horizontal rollers 84 are mounted to support frame 74. Vertical rollers 82 rotate about a vertical axis, while horizontal rollers 84 rotate about a horizontal axis. Rollers 82 and 84 are used to move a glass panel, as will be described in detail below. It should be appreciated that according to an alternative embodiment of manual conveyance system 70, horizontal rollers 84 may be driven by a motor-driven belt system (not shown).

Laser guide 88 and indexing unit 90 are mounted to vertical conveyor 72. Laser guide 88 facilitates alignment of a rack 15 with vertical conveyor 72, as will be explained below. Laser guide 88 emits a laser beam to assist an operator in alignment of a rack 15 in relation to vertical conveyor 72, as discussed below.

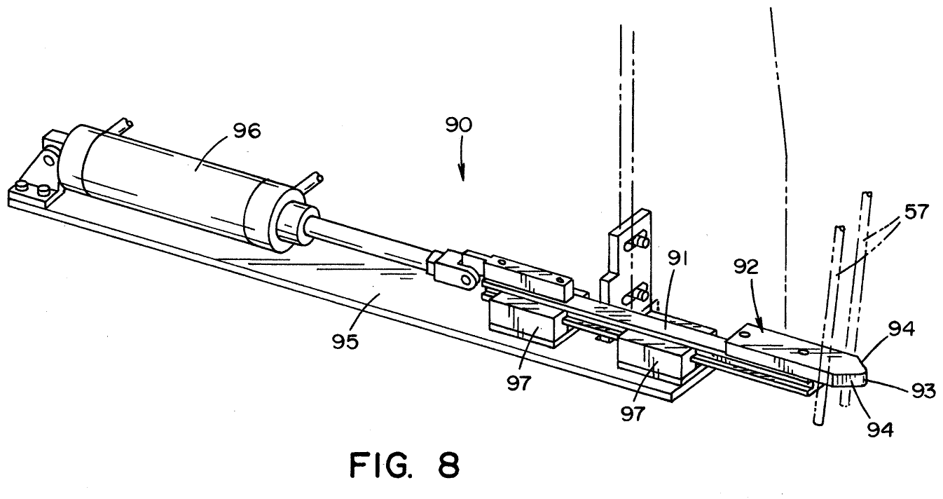

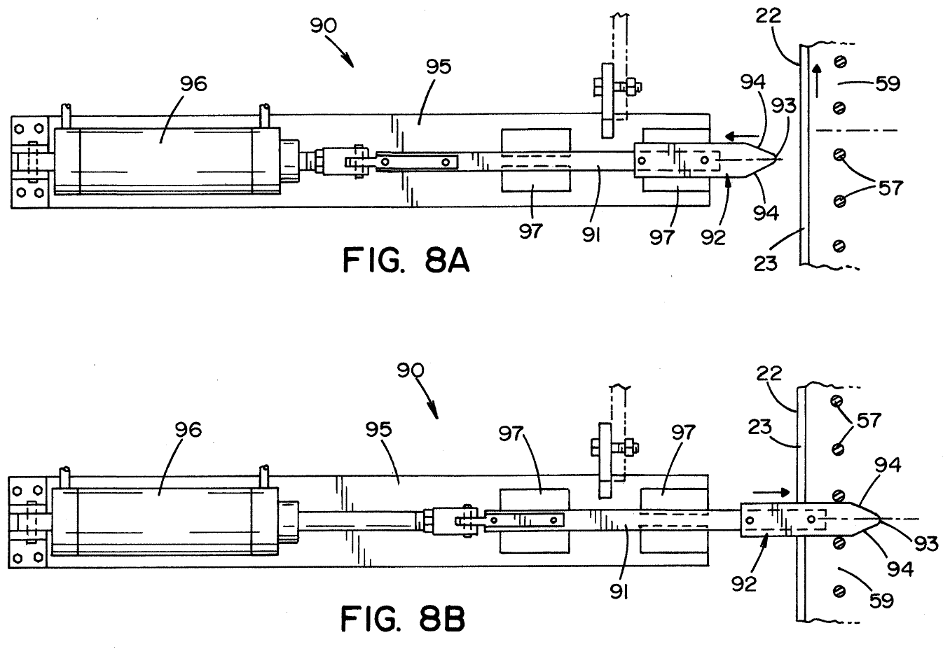

Indexing unit 90, best seen in FIG. 8, includes an arm 91 having a finger 92 located at a distal end thereof, one or more slotted guide elements 97, a piston/cylinder drive 96, and a mounting plate 95. The cylinder of piston/cylinder drive 96 and slotted guide elements 97 are mounted to mounting plate 95. A first end of arm 91 is attached to the distal end of the piston of piston/cylinder drive 96. A second end of arm 91 extends through the slots of slotted guide elements 97. As indicated above, finger 92 is located at a distal end of arm 91. In the illustrated embodiment, finger 92 has a front face 93 and a pair of side faces 94. Piston/cylinder drive 96 is actuated by a pneumatic actuator 110 (shown in FIG. 3) to move arm 91 of indexing unit 90 between a retracted position and an extended position. For example, pneumatic actuator 110 may take the form of a foot pedal controlled pneumatic actuator. FIG. 8A shows arm 91 in the retracted position and FIG. 8B shows arm 91 in the extended position. Operation of indexing unit 90 is described in detail below.

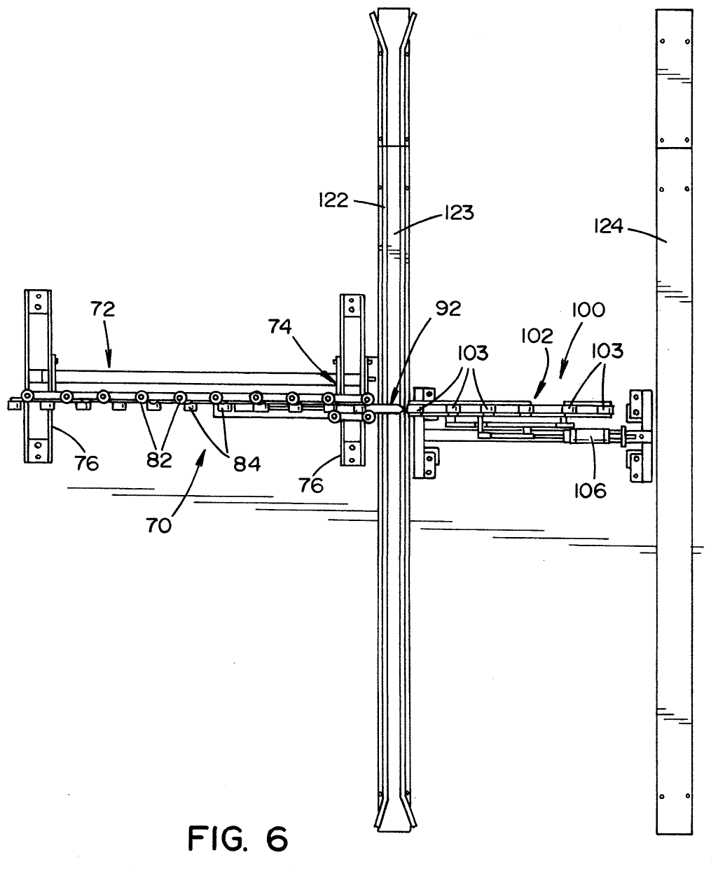

Referring to FIGS. 3 and 6, floor track assembly 120 facilitates general alignment of a rack 15 with vertical conveyor 72, as will be explained below. Floor track assembly 120 is comprised of wheel guides 122 and 124. Wheel guide 122 includes a channel 123 that is dimensioned to receive wheels 28 of rack 15. Wheel guide 124 provides a visual guide for wheels 28 of rack 15.

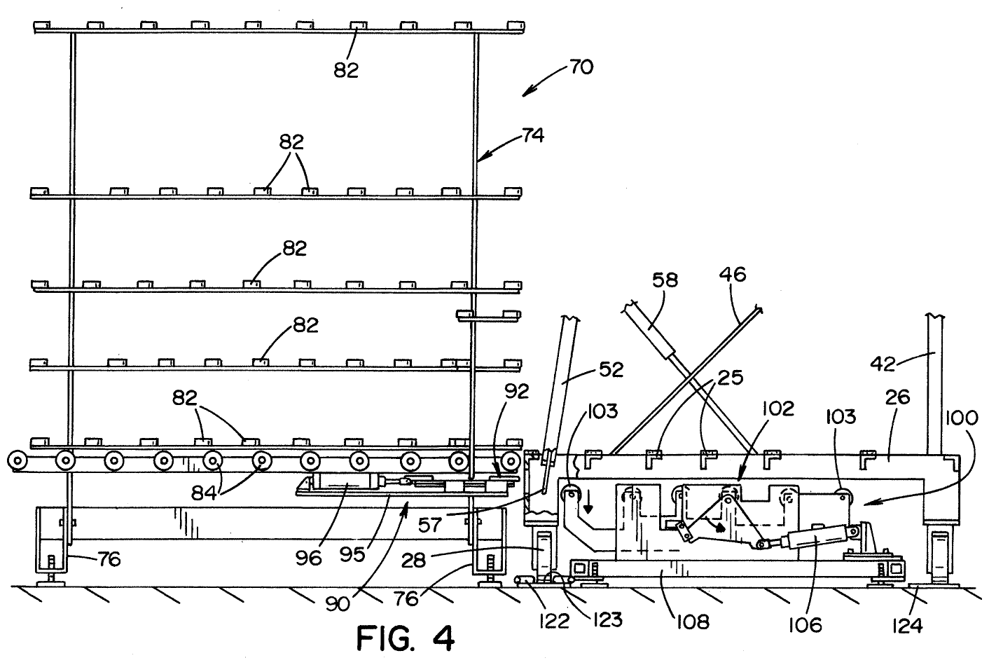

Referring to FIGS. 3 and 4, pop-up roller assembly 100 is generally comprised of a roller unit 102, a piston/cylinder drive 106, and a support base 108. Roller unit 102 includes a plurality of horizontal rollers 103 that rotate about a horizontal axis. Roller unit 102 is moveable between a raised position (as best seen in FIGS. 3 and 11) and a lowered position (FIG. 4). Movement of roller unit 102 between the raised and lowered positions is driven by piston/cylinder drive 106, which is actuated by pneumatic actuator 110, which also actuates indexing unit 90. In this regard, activation of pneumatic actuator 110 simultaneously (1) moves indexing unit 90 from the retracted position to the extended position, and (2) moves roller unit 102 from the lowered position to the raised position. Likewise, deactivation of pneumatic actuator 110 simultaneously returns indexing unit 90 to the retracted position and roller unit 102 to the lowered position. It should be appreciated that when roller unit 102 is located in the raised position, horizontal rollers 103 are aligned linearly with horizontal rollers 84 of vertical conveyor 72 along a horizontal axis.

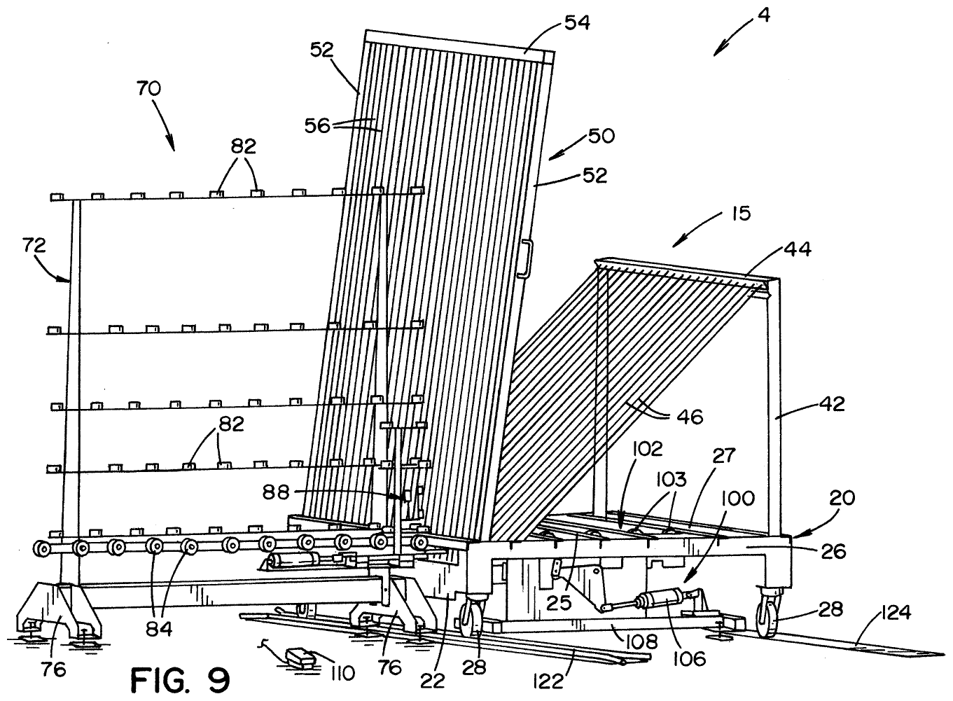

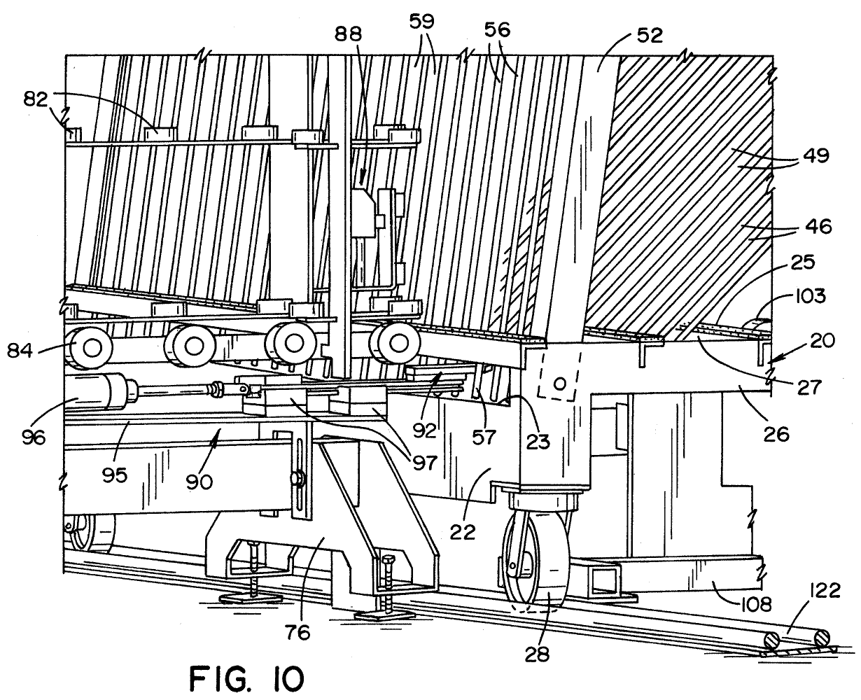

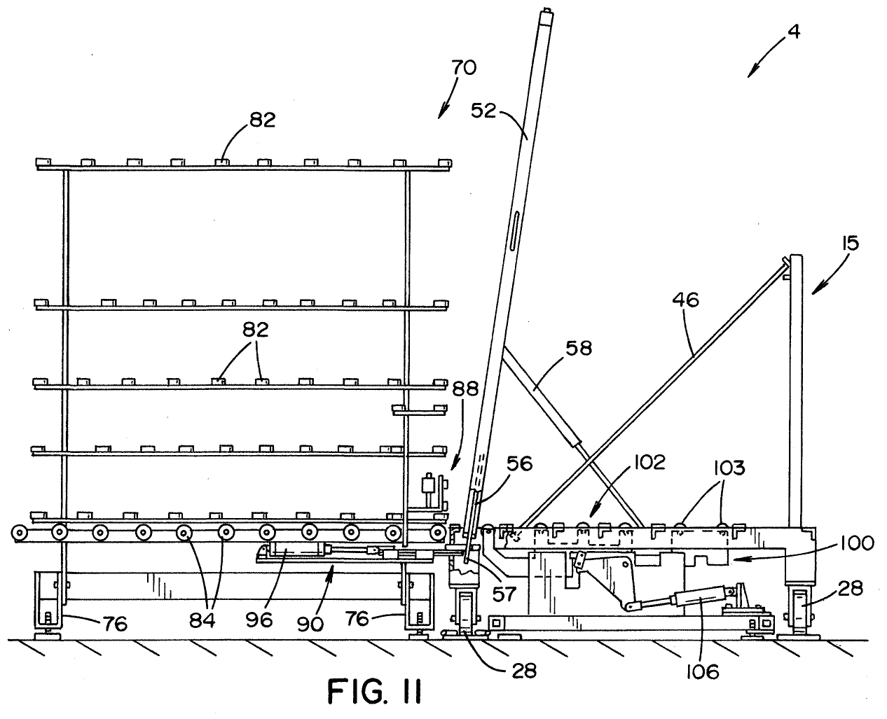

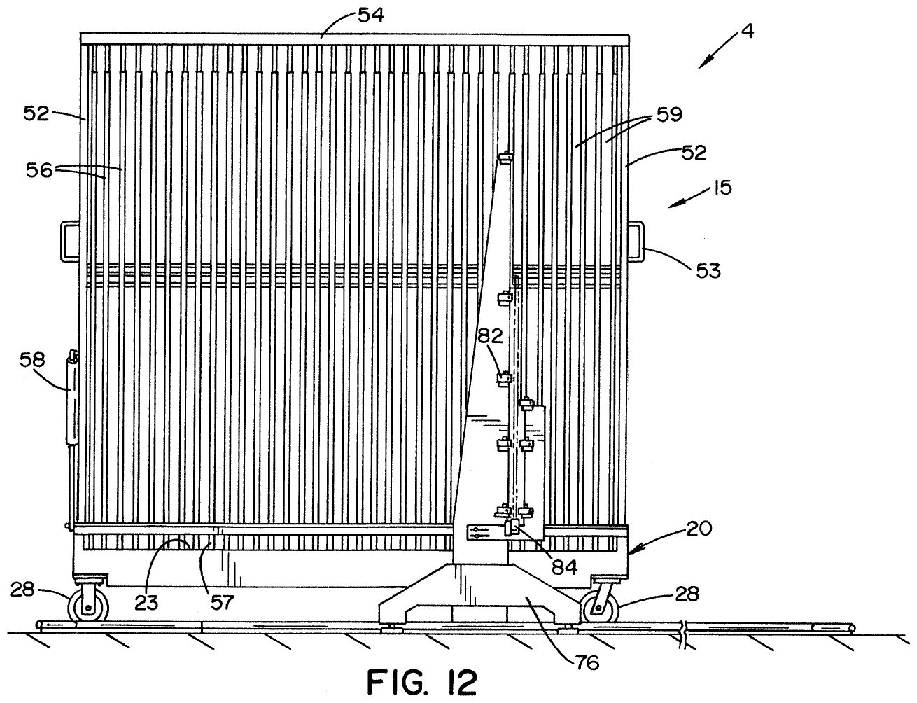

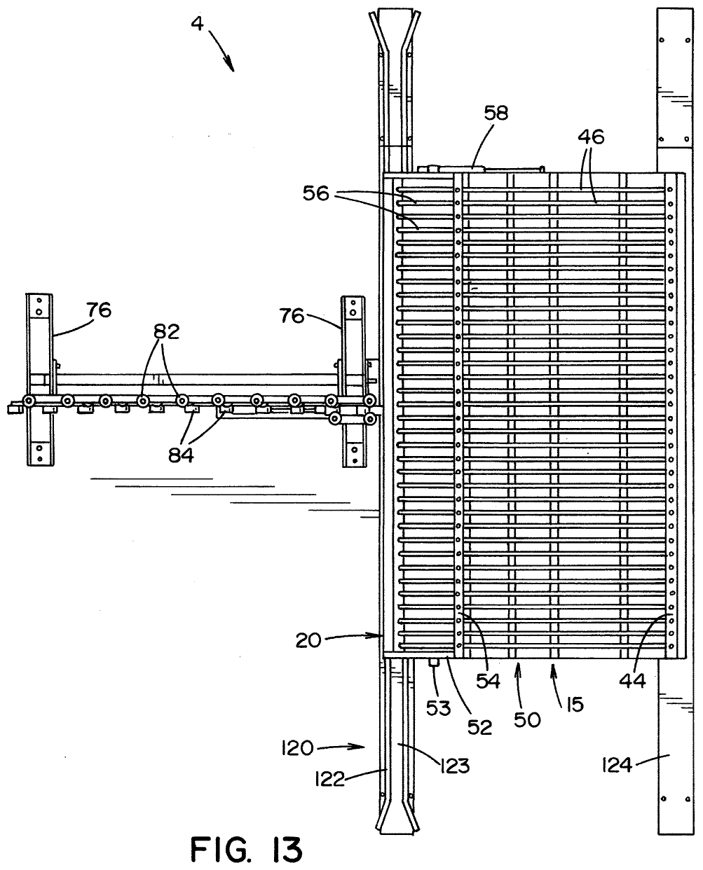

FIGS. 9-13 illustrate a manual racking system 4 comprising manual conveyance system 70 and rack 15. Operation of manual racking system 4 is described in detail below.

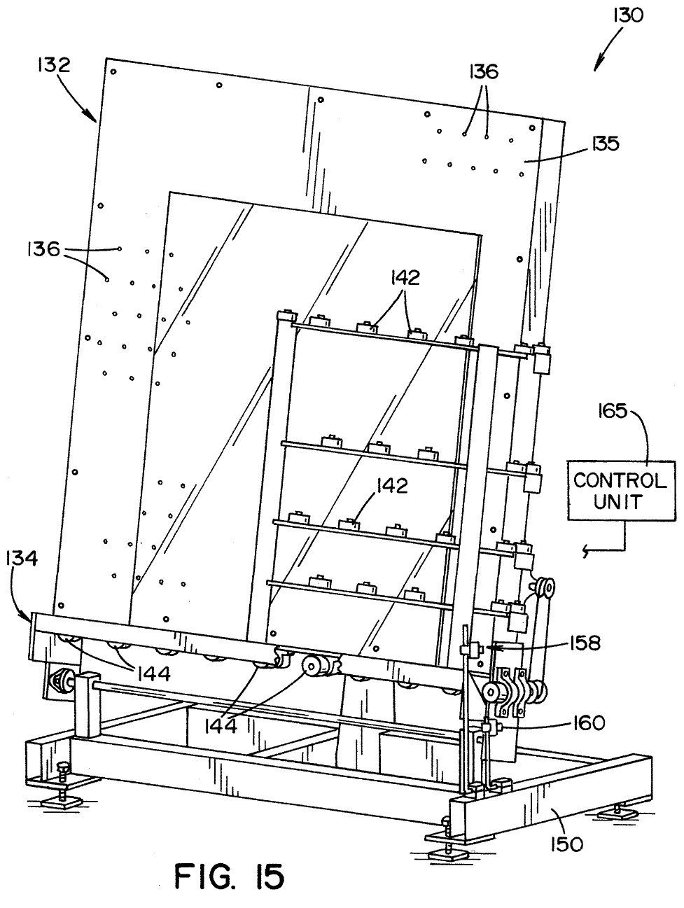

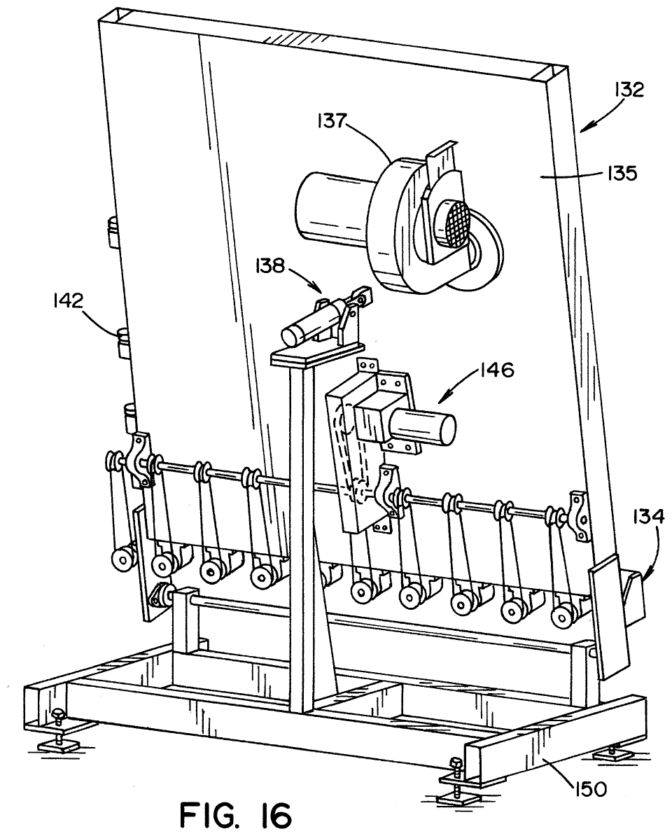

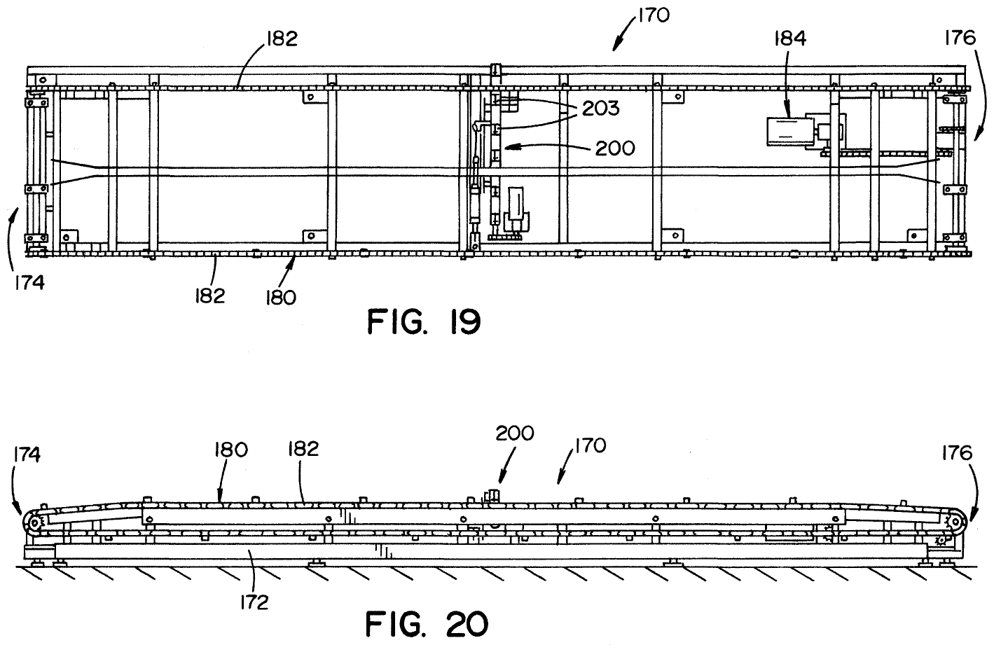

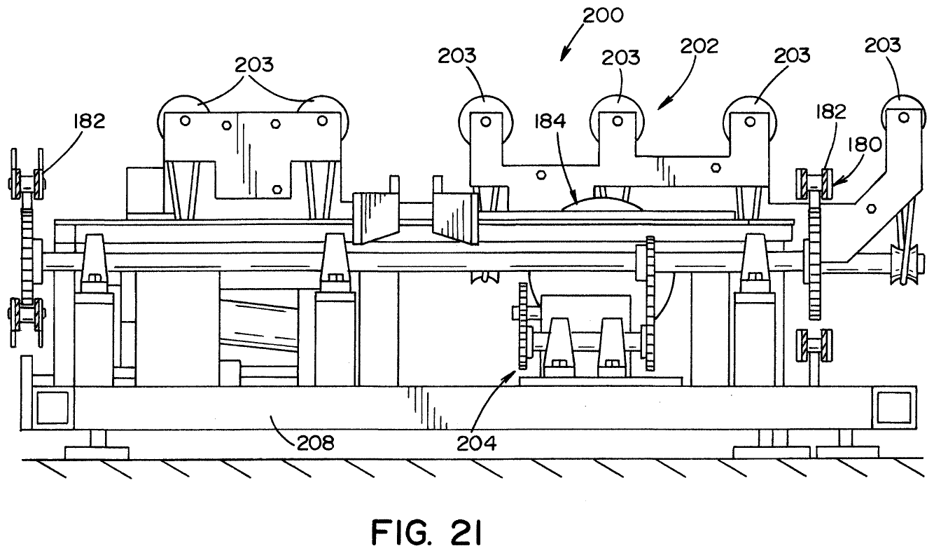

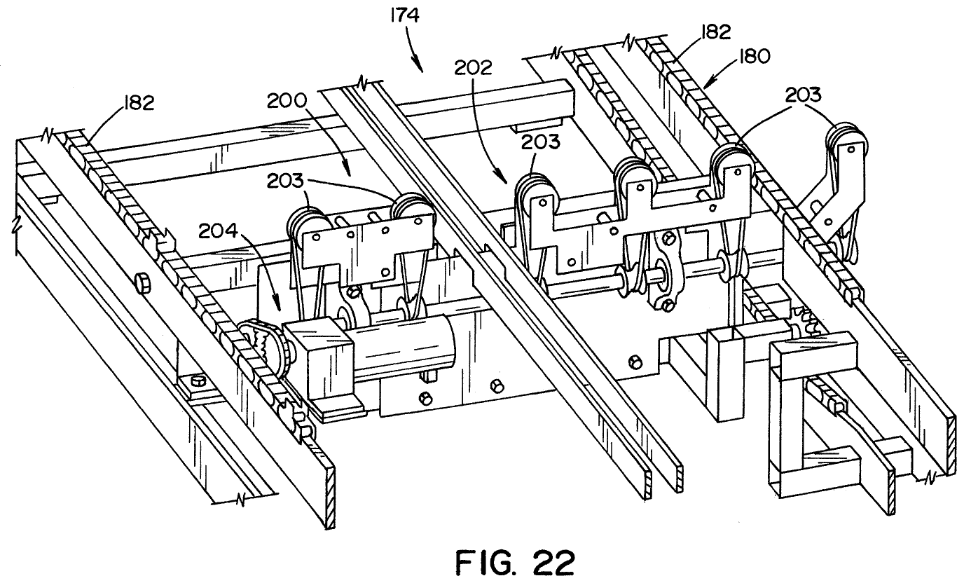

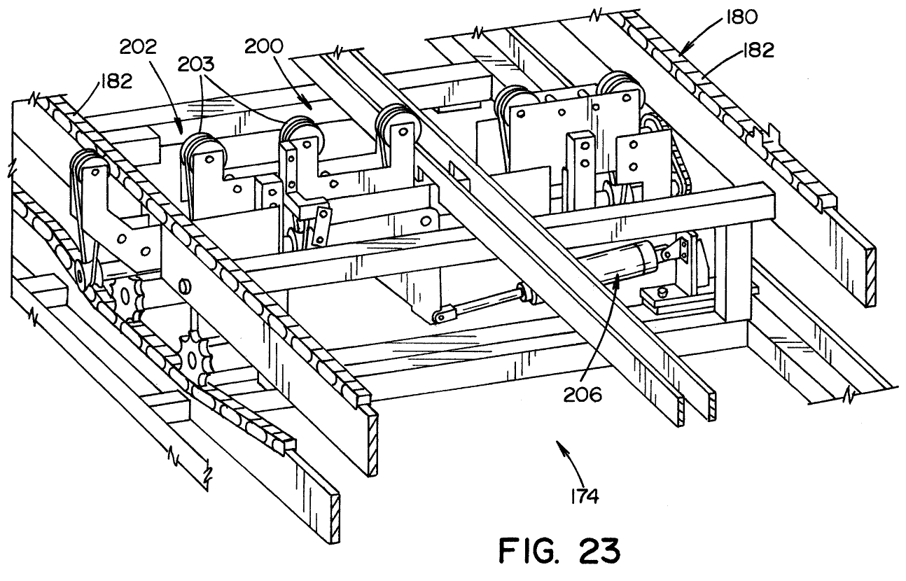

Referring now to FIGS. 15-23, an automated conveyance system 130 will now be described. Automated conveyance system 130 is generally comprised of a vertical tilt conveyor 132, a laser guide 158, a laser sensor 160, and a rack indexer assembly 170 that includes a frame 172, a drag chain assembly 180, and a pop-up roller assembly 200.

With reference to FIGS. 15-17, vertical tilt conveyor 132 includes a support frame 134 and a base 150. Support frame 134 includes a panel 135 that is pivotally mounted to base 150. Panel 135 includes a plurality of holes 136 that are in fluid communication with a blower unit 137. Vertical tilt conveyor 132 also includes a tilt drive 138 comprised of a piston/cylinder system for tilting panel 134. A plurality of vertical rollers 142, which rotate about a vertical axis, are mounted to support frame 134. A plurality of horizontal rollers 144 are also mounted to panel 135. Horizontal rollers 144 rotate about a horizontal axis and are driven by a motorized drive belt system 146, best seen in FIG. 17.

Laser guide 158 and laser sensor 160 are mounted to support frame 134. Laser guide 158 emits a laser beam that is directed toward a rack 15 that is located on rack indexer assembly 170. Laser sensor 160 detects reflections of the laser beam produced by laser guide 158. Operation of laser guide 158 and laser sensor 160 are described in further detail below.

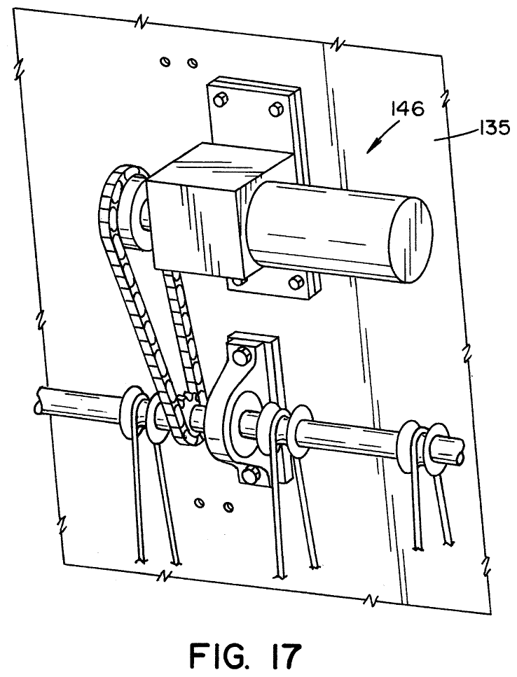

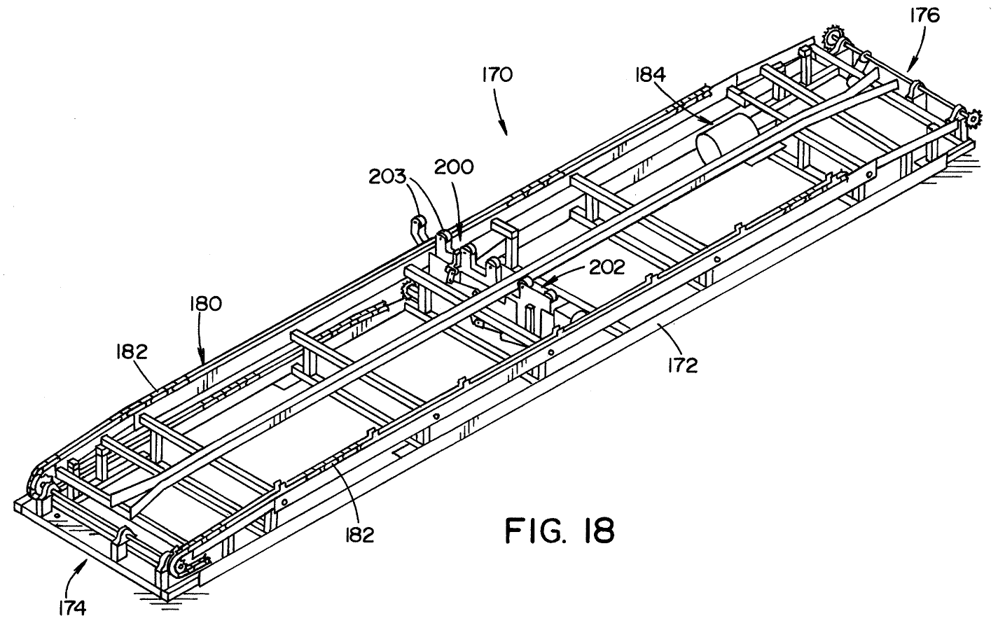

Rack indexer assembly 170 will now be described with reference to FIGS. 18-23. Rack indexer assembly 170 is generally comprised of an elongated frame 172, a drag chain assembly 180, and a pop-up roller assembly 200. Elongated frame 172 defines a travel path adjacent to vertical tilt conveyor 132, and has a feed end 174 for receiving a rack 15 and an exit end 176 for outputting a rack 15. Drag chain assembly 180 engages with rack 15 and advances rack 15 along the travel path. Drain chain assembly 180 is comprised of a pair of metal chains 182 and a motorized sprocket drive assembly 184.

Pop-up roller assembly 200 is mechanically similar to pop-up roller assembly 100 described above. As best seen in FIG. 21, pop-up roller assembly 200 is comprised of a roller unit 202, a piston/cylinder drive 206, and a support base 208. Roller unit 202 includes a plurality of horizontal rollers 203 that rotate about a horizontal axis and are driven by a motorized drive belt system 204. Roller unit 202 is moveable between a raised position and a lowered position. Movement of roller unit 202 between the raised and lowered positions is driven by piston/cylinder drive 206. It should be appreciated that when roller unit 202 is located in the raised position, horizontal rollers 203 are aligned linearly with horizontal rollers 144 along a horizontal axis.

Automated conveyance system 130 also includes a control unit 165 (shown in FIG. 15) for controlling the automated loading/unloading of glass panels to/from rack 15. Control unit 165 is generally comprised of a conventional computer control system and a user interface. Control unit 165 controls operation of tilt drive 138 and motorized drive belt system 146 of vertical tilt conveyor 132, motorized sprocket drive assembly 184 of drag chain assembly 180, motorized drive belt system 204 and piston/cylinder drive 206 of pop-up roller assembly 200. Control unit 165 also receives and processes signals from laser sensor 160 that detects reflected light produced by laser guide 158 in order to determine the position of a rack 15 relative to vertical tilt conveyor 132.

FIGS. 24-26 illustrate an automated racking system 6 comprising automated conveyance system 130 and rack 15. Operation of automated racking system 6 is described in detail below.

Operation of manual racking system 4 for a loading operation will now be described with particular reference to FIGS. 10 and 11. An operator guides rack 15 into position adjacent to vertical conveyor 72 by aligning wheels 28 with wheel guides 122 and 124 of floor track assembly 120. Rack 15 is placed in general alignment with vertical conveyor 72 by the operator locating rack 15 at a position whereby the laser beam of laser guide 88 projects into a slot 59 between adjacent rods 56 of pivoting rack member 50. Thereafter, rack 15 is placed in alignment with vertical conveyor 72 by the operator actuating pneumatic actuator 110. As discussed above, activation of the pneumatic actuator causes arm 91 of indexing unit 90 to move from the retracted position (FIG. 8A) to the extended position (FIG. 8B). As arm 91 of indexing unit 90 moves to the extended position, finger 92 extends through aperture 23 of base frame 20 into a slot 59 between the lower end portions 57 of a pair of rods 56. Slots 59 defined by rods 56 are dimensioned to receive finger 92. If the general alignment is not sufficiently precise, then side faces 94 will contact one of the lower ends of the rods as arm 91 moves to the fully extended position, thereby causing rack 15 to move into alignment with vertical conveyor 72. Furthermore, in the fully extended position, finger 92 of indexing unit 90 locks rack 15 in the aligned position relative to vertical conveyor 72.

Simultaneous with movement of arm 91 to the extended position, roller unit 102 of pop-up roller assembly 100 moves from the lowered position to the raised position. In the raised position, rollers 103 extend through openings 27 located between cross supports 25.

Once rack 15 is aligned and locked in position by finger 92 of indexing unit 90, and roller unit 102 is moved to the raised position, the operator can manually move a glass panel from vertical conveyor 72 into an aligned slot of rack 15. The aligned slot of rack 15 is defined by slot 49 of fixed rack member 40 and slot 59 of pivoting rack member 50. This movement of the glass panel is facilitated by vertical rollers 82 and horizontal rollers 84 of vertical conveyor 72, and by horizontal rollers 103 of pop-up roller assembly 100. As indicated above, according to an alternative embodiment of manual conveyance system 70, horizontal rollers 82 may be driven by a motor-driven belt system.

After the glass panel is loaded into a slot on rack 15, the operator deactivates the pneumatic actuator, thereby simultaneously causing arm 91 of indexing unit 90 to move from the extended position to the retracted position, and causing roller unit 102 to move from the raised position to the lowered position. As arm 91 moves to the retracted position, rack 15 is unlocked. As roller unit 102 moves to the lowered position, the bottom surface of the glass panel located in the slot of rack 15 is gently placed onto the top surfaces of cross supports 25. Rack 15 can now be manually advanced by the operator to align the next slot of rack 15 to be loaded with vertical conveyor 72. In accordance with the present invention, rack 15 can be loaded non-sequentially.

The foregoing steps are reversed for an unloading operation whereby glass panels are manually unloaded from rack 15 onto vertical conveyor 72.

It is contemplated that there are alternative means by which the indexing and locking function provided by use of finger 92 can implemented in accordance with the present invention. For example, in the alternative embodiment of rack 15 shown in FIG. 2A, aperture 23 of front support 22 is replaced with spaced openings 33 that are dimensioned to receive finger 92. Spaced openings 33 substitute for the function served by slots 59, defined by rods 56, located at lower end portion 57 of rods 56.

In accordance with an alternative embodiment of the present invention, the indexing unit may be adapted to align an open slot of rack 15 with horizontal rollers 84 of vertical conveyor 72, and also advance rack 15 along floor track assembly 120 such that the next slot of rack 15 is aligned with horizontal rollers 84 of vertical conveyor 72. Therefore, the indexing unit according to the alternative embodiment adds some level of automation to manual conveyance system 70, as will be described below.

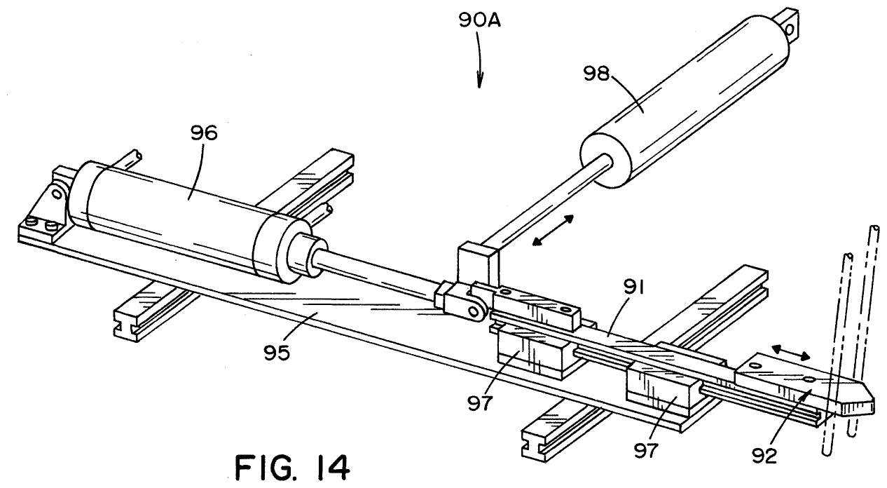

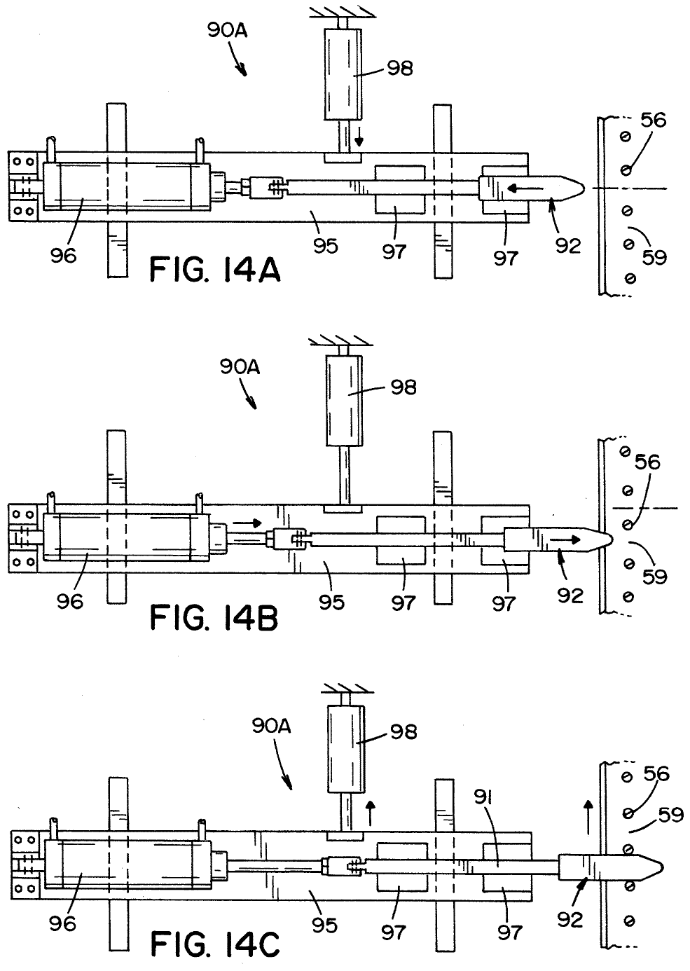

Referring now to FIG. 14, there is shown an indexing unit 90A according to the alternative embodiment. Indexing unit 90A includes a second piston/cylinder drive 98 in addition to first piston/cylinder drive 96. The cylinder of piston/cylinder drive 98 is fixed to support frame 74 of vertical conveyor 72. The distal end of the piston of piston/cylinder drive 98 is connected to mounting plate 95. Extension of the piston of piston/cylinder drive 98 moves mounting plate 95, and thereby moves arm 91 from a home position to a forward position (FIG. 14A). Retraction of the piston of piston/cylinder drive 98 moves mounting plate 95 such that arm 91 returns back to the home position (FIG. 14C). In this embodiment, pneumatic actuator 110 may also function to activate and deactivate piston/cylinder drive 98, wherein activation of piston/cylinder drive 98 moves arm 91 from the home position to the forward position, and deactivation of piston/cylinder drive 98 returns arm 91 from the forward position to the home position. By use of pneumatic actuator 110, movement of arm 91 between the home/forward positions may be synchronized with movement of arm 91 between the retracted/extended positions and the movement of roller unit between lowered/raised positions.

Referring now to FIG. 14A-14C, operation of indexing unit 90A will be described. In FIG. 14A the piston of drive 96 is retracted thereby moving arm 91 to the retracted position, and the piston of drive 98 is extended thereby moving arm 91 to the forward position. In the forward position, arm 91 is in alignment with the next slot of rack 15. Next, the piston of drive 96 is extended to move arm 91 to the extended position, whereby finger 92 extends through aperture 23 of base frame 20, received into a slot 59, and captured between a pair of rods 56, as shown in FIG. 14B. Thereafter, piston of drive 98 is retracted causing arm 91 to return to the home position. As arm 91 moves from the forward position to the home position it advances rack 15 along floor track assembly 120 such that the next open slot of rack 15 is aligned with horizontal rollers 84 of vertical conveyor 72. As can be seen in FIGS. 14A-14C, piston/cylinder 96 moves arm 91 along a first axis (between the retracted and extended positions), while piston/cylinder drive 98 moves arm 91 along a second axis (between the home and forward positions), wherein the first axis is transverse to the second axis.

It should be appreciated that the operation of indexing unit 90A can be reversed to unload glass panels 10 from rack 15 onto a conveyor or other processing equipment.

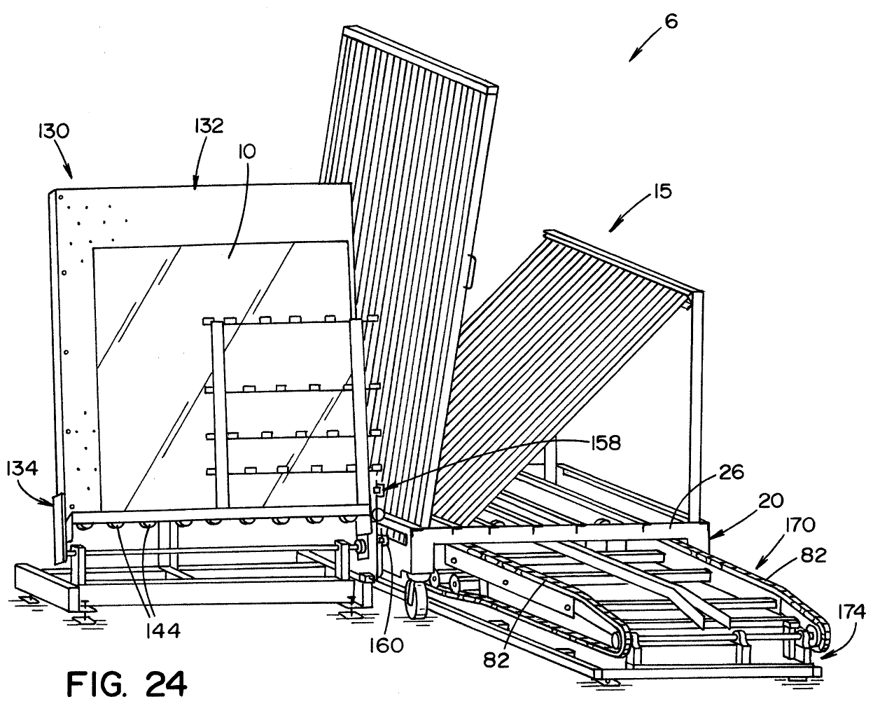

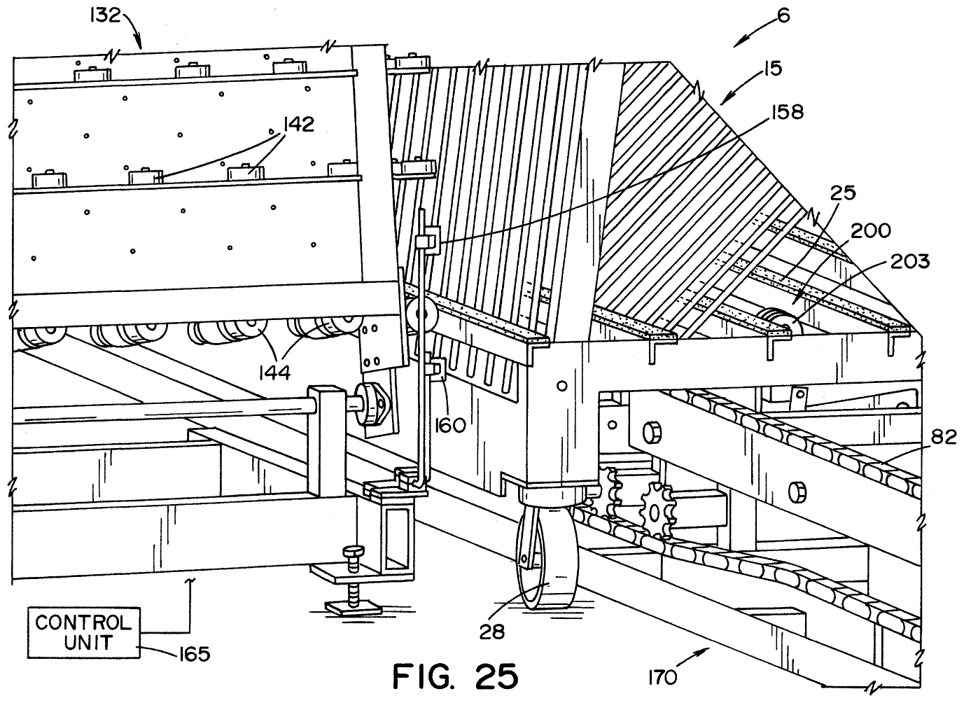

Operation of automated racking system 6 for a loading operation will now be described with particular reference to FIGS. 24 and 25. An operator guides rack 15 onto rack indexer assembly 170 whereby the lower surface of side supports 26 engage with the upper surface of metal chains 82. Control unit 165 activates motorized sprocket drive assembly 184 to advance a desired slot of rack 15 into alignment with vertical tilt conveyor 132. In this regard, control unit 165 uses laser guide 158 and associated laser sensor 160 to determine alignment of rack 15 relative to conveyor 132 by sensing the laser beam light reflected by rods 56 as rack 15 moves along the travel path of rack indexer assembly 170. Once control unit 165 determines that rack 15 has moved into proper alignment with vertical tilt conveyor 132 based upon the amount of reflected light detected by laser sensor 160, control unit 165 deactivates motorized sprocket drive assembly 184 to stop advancement of rack 15 along the travel path and activates piston/cylinder drive 206 of pop-up roller assembly 200 to move roller unit 202 from the lowered position to the raised position. Thereafter, control unit 165 activates the motorized drive belt systems 146 and 204, which are respectively associated with driving horizontal rollers 144 of vertical tilt conveyor 132 and horizontal rollers 203 of pop-up roller assembly 200. As a result, glass panel 10 is automatically moved from vertical tilt conveyor 132 into an aligned slot of rack 15.

After the glass panel is loaded into a slot of rack 15, control unit 165 deactivates motorized drive belt systems 146 and 204, and causes piston/cylinder drive 206 of pop-up roller assembly 200 to return roller unit 202 from the raised position to the lowered position. As roller unit 202 moves to the lowered position, the bottom surface of the glass panel is gently placed onto the top surfaces of cross supports 25.

Next, control unit 165 activates motorized sprocket drive assembly 184 to advance rack 15 along the travel path to locate the next slot of rack 15 into alignment with vertical tilt conveyor 132. In this manner, control unit 165 is operable to automatically index each slot of rack 15 to load glass panels from vertical tilt conveyor 132. It should be appreciated that control unit 165 of automated racking system 6 can be programmed to load rack 15 non-sequentially.

The foregoing steps are reversed for an unloading operation whereby glass panels are unloaded from rack 15 onto a conveyor or other processing equipment.

It is contemplated that there are alternative means by which the indexing function of the automated conveyance system 130 can be implemented in accordance with the present invention. For example, reflective elements or other markings can be used by control unit 165 to detect the position of rack 15 relative to vertical tilt conveyor 132 as it advances along the travel path of rack indexer assembly 170.

In the above-illustrated embodiment of automated racking system 6, rack indexer assembly 170 is used in combination with a vertical tilt conveyor 132. In the embodiment of the present invention described below, an automated production system 8 is described wherein rack indexer assembly 170 is used in combination with a glass panel fabricating system 220.

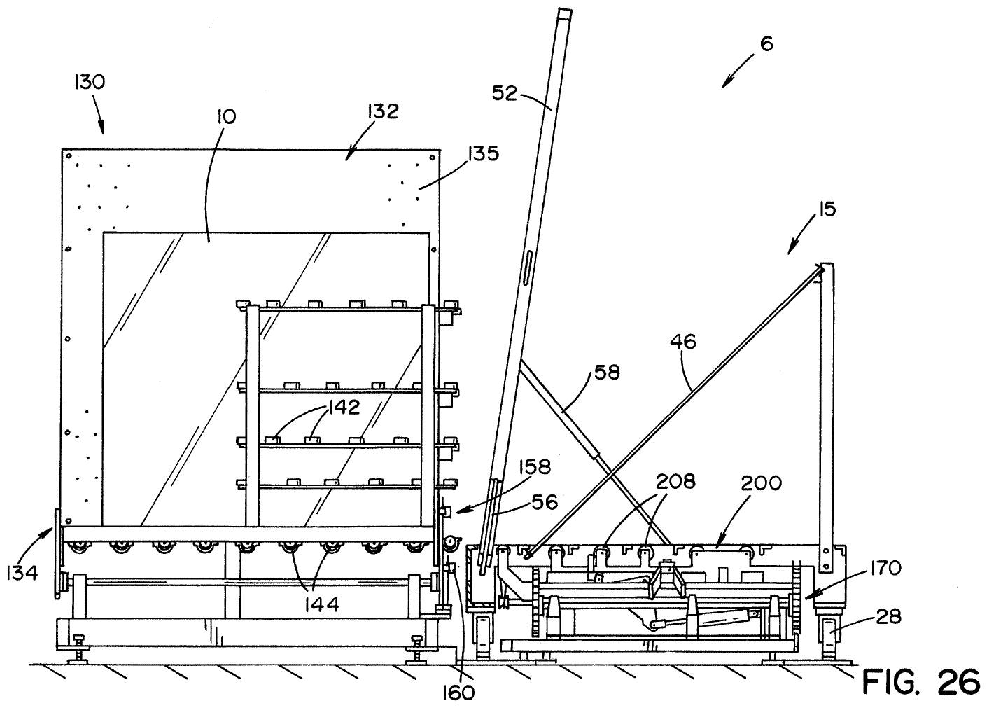

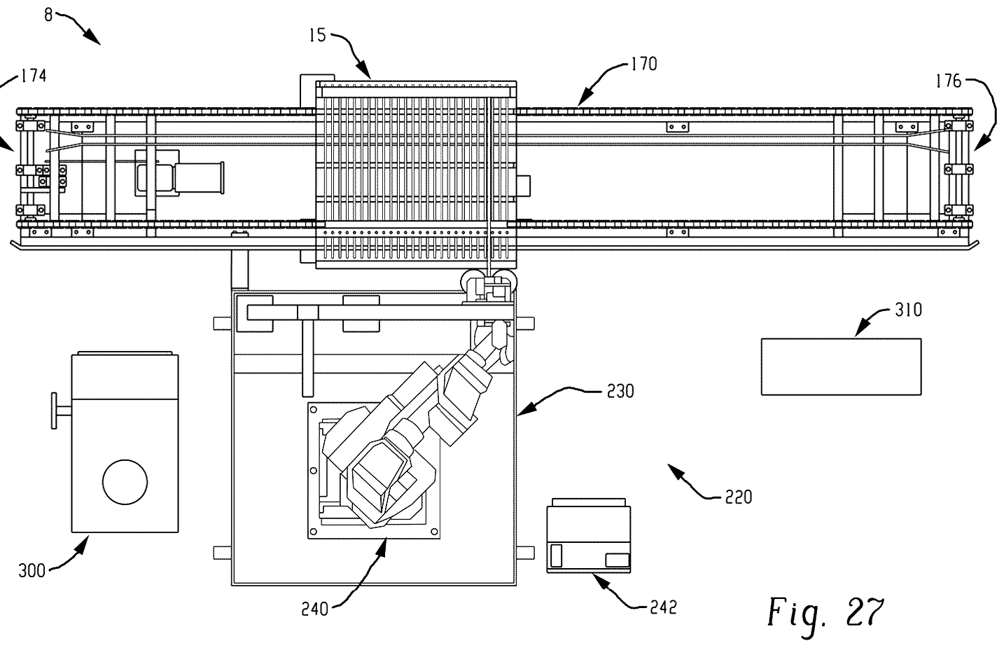

Referring now to FIG. 27, there is shown an overhead view of automated production system 8 for patching glass panels. In the illustrated embodiment, the glass panels take the form of conventional insulating glass units (IGU) comprised of two panes of glass separated by a spacer frame and sealed together at the edge. The insulating space between the two panes of glass is filled with an inert gas, such as argon or krypton. In the illustrated embodiment, automated production system 8 operates to seal the hole in the spacer material that is used to fill the insulating space with gas.

Automated production system 8 is generally comprised of glass panel fabricating system 220, rack indexer assembly 170, and rack 15. As discussed in detail above, rack indexer assembly 170 includes frame 172, drag chain assembly 180, and pop-up roller assembly 200. In the illustrated embodiment, rack indexer assembly 170 includes a cam guide which is dimensioned to receive a cam follower mounted to rack 15. The cam guide facilitates guidance of rack 15 along the travel path of rack indexer assembly 170.

According to one embodiment of the present invention, fabricating system 220 is generally comprised of an industrial robot system 230, a roller guide assembly 270, a support member 290, and a pump 300.

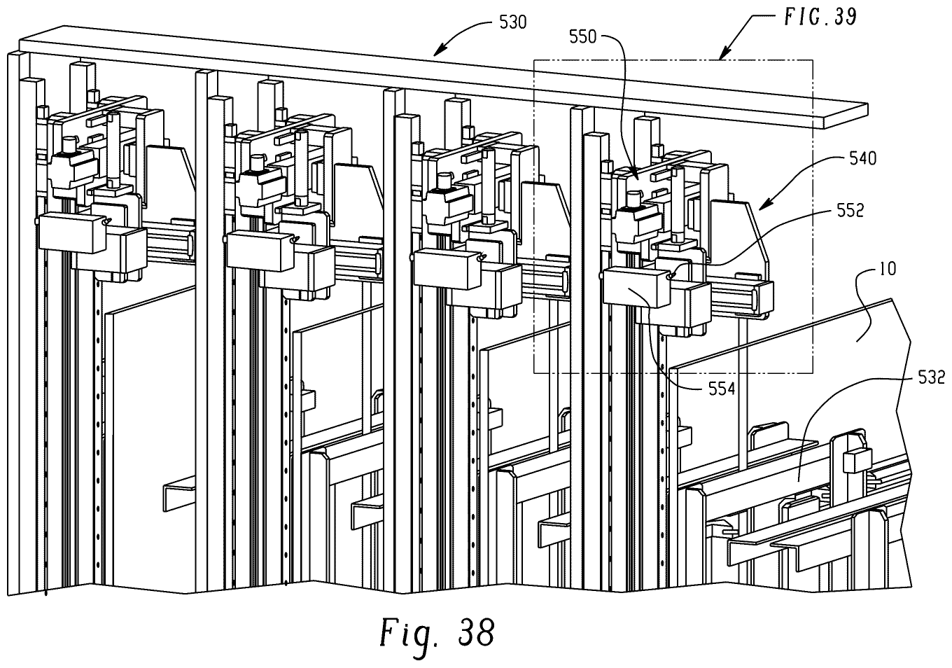

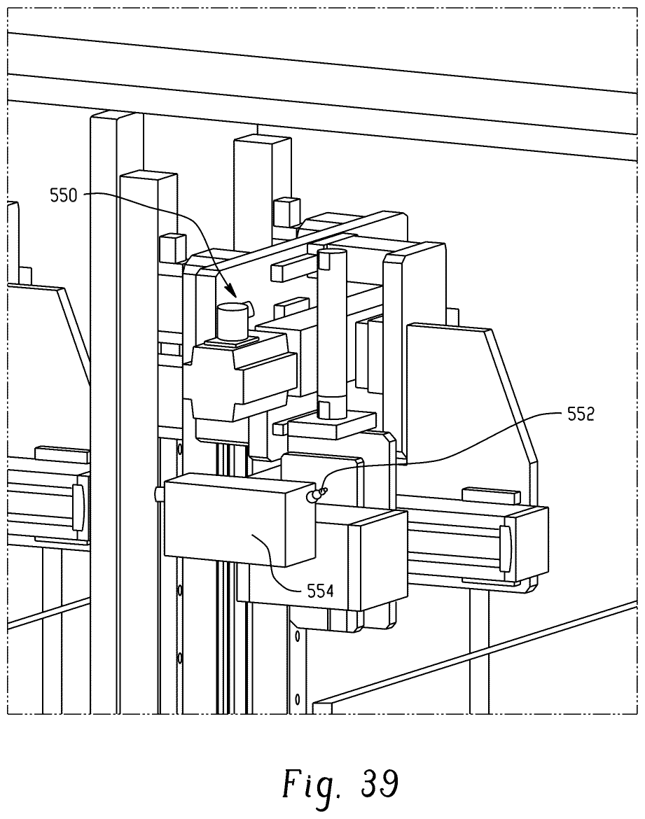

In the illustrated embodiment, industrial robot system 230 is generally comprised of a conventional 6-axis industrial robot 240 that is controlled by a robotic controller 242. Robot 240 includes an arm 244 having one or more end-of-arm tools (EOAT) 250 mounted at the distal end thereof. In the illustrated embodiment, EOATs 250 include a pneumatic clamping tool 252 (see FIGS. 40-41) having rollers 254, and a dispensing nozzle tool 262 (see FIGS. 38-39) for dispensing an insulating glass sealant (such as a conventional butyl sealant) to seal an IGU. Dispensing nozzle tool 262 is in fluid connection with pump 300 via a hose (not shown) for receiving the sealant.

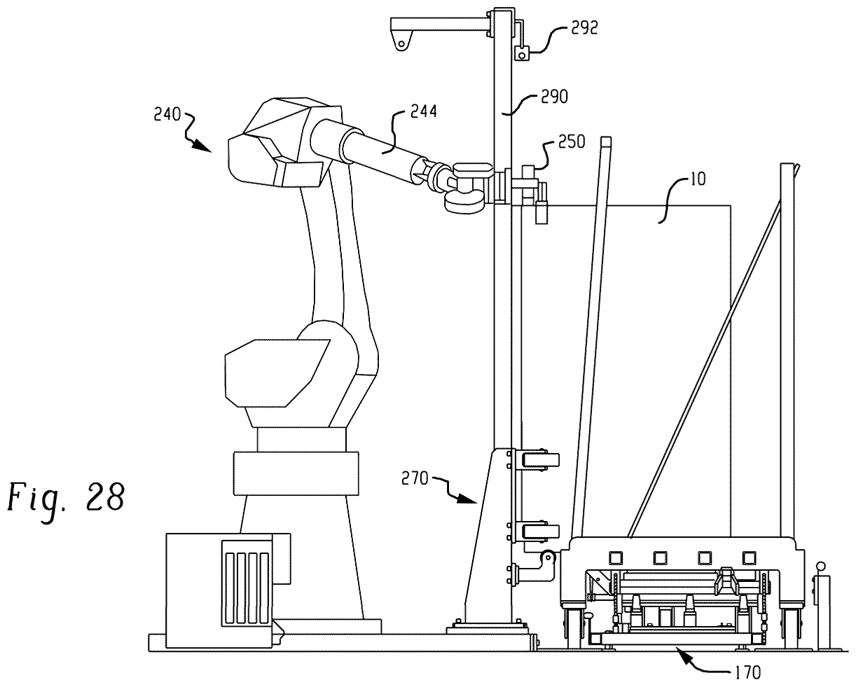

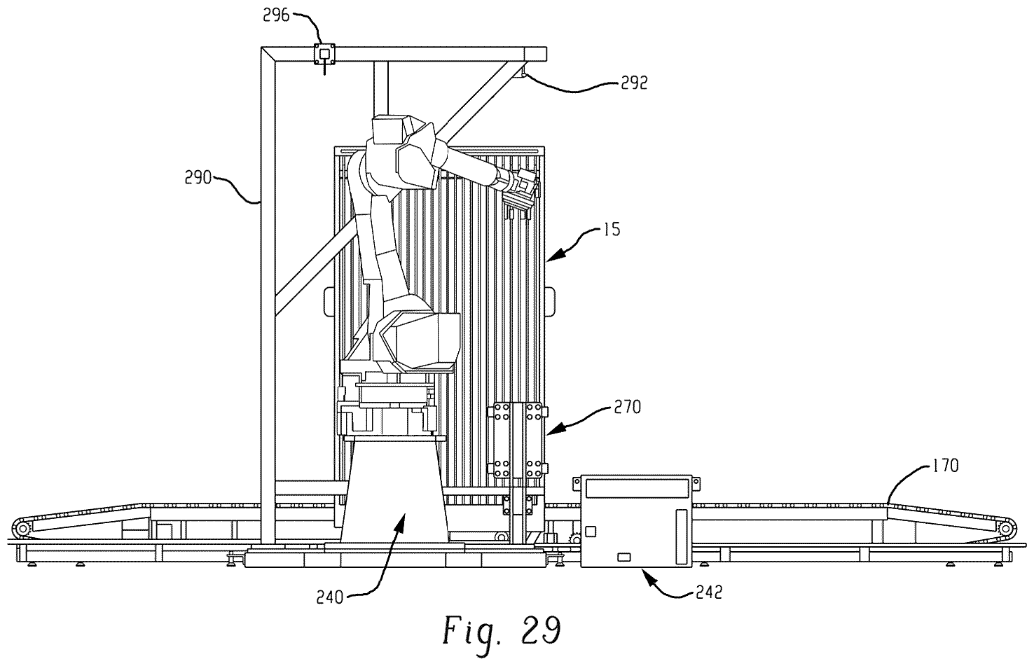

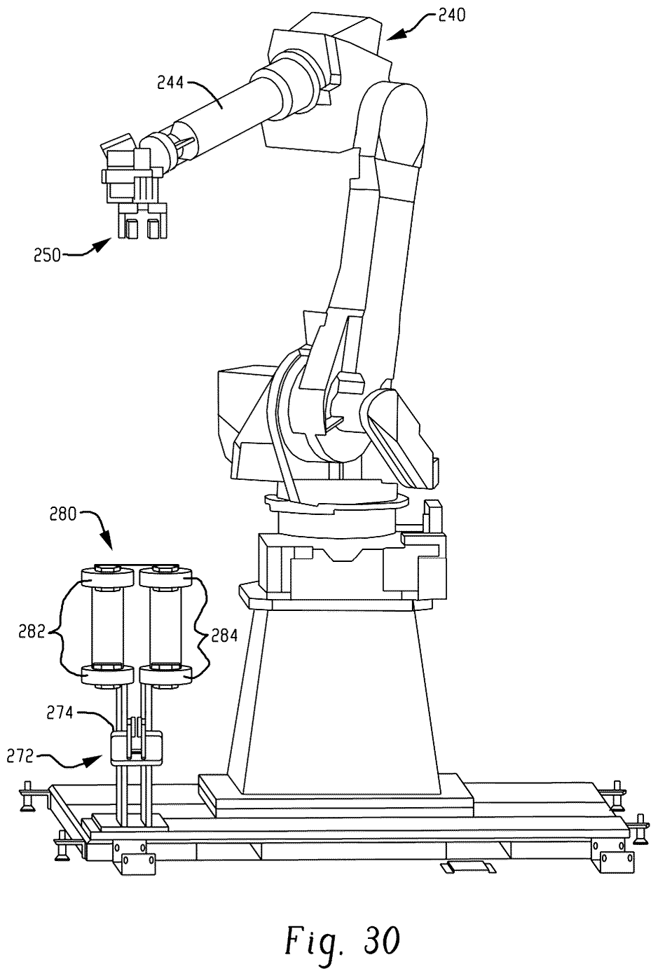

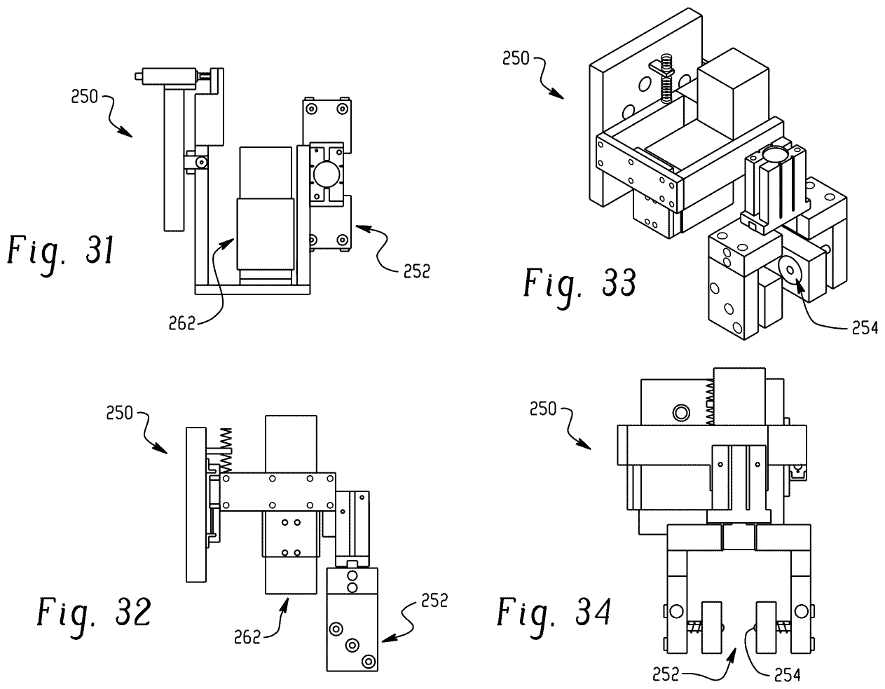

Roller guide assembly 270 will now be described in detail with reference to FIGS. 28, 29, and 37. In the illustrated embodiment, roller guide assembly 270 includes a horizontal roller 274 and an alignment roller assembly 280. A mounting member 272 supports horizontal roller 274 and alignment roller assembly 280.

Horizontal roller 274 rotates about a horizontal axis and acts as a vertical support for an IGU, as will be described below.

Alignment roller assembly 280 is comprised of first and second pairs of vertical rollers 282, 284. Vertical rollers pairs 282 and 284 are spaced apart to form a gap dimensioned to receive an IGU, as will be described below. Vertical roller pairs 282, 284 rotates about a vertical axis. It should be appreciated that alignment roller assembly 280 may also include a pair of elongated clamping plates (not shown) to capture an IGU.

Roller guide assembly 270 also includes a laser guide 158 (not shown) and a laser sensor 160 (not shown), which operate in the same manner discussed above in connection with automated conveyance system 130.

Support member 290 is configured to support a laser height sensor 292 and a hose support 296. Laser height sensor 292 provides data to the robotic controller 242 indicative of the detected height of an IGU. Hose support 296 supports the hose (not shown) that supplies sealant from pump 300 to dispensing nozzle tool 262.

Automated production system 8 also includes a control panel 310 for housing control unit 165 described above, which provides overall control of automated production system 8. In this embodiment of the present invention, control unit 165 is in communication with robotic controller 242, sensor 292, and pump 300.

It should be appreciated that automated production system 8 may also be adapted to perform a gas filling operation, wherein an IGU is filled with gas in advance of the patching operation. According to this embodiment of the present invention, robot 240 further comprises a conventional robotic vision system (not shown) and additional EOATs (not shown). The additional EOATs include a punching tool (not shown) for “hole conditioning,” a gas filling tool (not shown) having a nozzle in fluid communication with a source of gas (not shown), and a hole plugging tool (not shown), such as a screwfeeder.

The vision system is used to located the center of a fill hole and detect the area of the hole opening. The detected area is used to determine if the hole opening indicates a misalignment problem with the spacer frame. If a misalignment problem is detected, then robot 240 is programmed to punch the fill hole using the punch tool to correct the alignment. Thereafter, robot 240 is programmed to fill the IGU with gas using the gas filling tool to inject gas into the IGU. Next, robot 240 is programmed to plug the fill hole using the hole plugging tool.

According to an alternative embodiment, automated production system 8 may include a second 6-axis robot that is adapted for performing the gas filling operation described above. The second robot is located adjacent to robot 240 to fill an IGU with gas before robot 240 seals the IGU. The second robot is also controlled by robot controller 240.

Operation of automated production system 8 will now be described with particular reference to FIGS. 27-29 and 37-41. A rack 15 is loaded with one or more IGUs.

In the illustrated embodiment, the IGUs are loaded onto rack 15 according to the embodiment of the invention described above in connection with automated racking system 6. The automated racking system 6 is programmed to load all of the IGUs such that the front edges of all IGUs are substantially flush with each other (e.g., all IGUs are loaded such that the front edge of the IGUs are flush with the front edge of rack 15). In the illustrated embodiment, the loaded IGUs may be of varying dimensions (e.g., different heights and widths). A typical rack 15 is adapted to transport 1-50 IGUs. However, it is contemplated that the dimensions of rack 15 may be scaled up to transport larger numbers of IGUs.

An operator guides rack 15 loaded with one or more IGUs onto rack indexer assembly 170 whereby the lower surface of side supports 26 engages with the upper surface of metal chains 82. Control unit 165 activates motorized sprocket drive assembly 184 to advance a desired slot of rack 15 into alignment with roller guide assembly 270. In the same manner as described above with reference to automated racking system 6, control unit 165 uses laser guide 158 and associated laser sensor 160 to determine alignment of rack 15 relative to roller guide assembly 270 by sensing the laser beam light reflected by rods 56, as rack 15 moves along the travel path of rack indexer assembly 170. Once control unit 165 determines that rack 15 has moved into proper alignment with roller guide assembly 270 based upon the amount of reflected light detected by laser sensor 160, control unit 165 deactivates motorized sprocket drive assembly 184 to stop advancement of rack 15 along the travel path and activates piston/cylinder drive 206 of pop-up roller assembly 200 to move roller unit 202 from the lowered position to the raised position. Thereafter, control unit 165 activates the motorized drive belt system 204, which drives horizontal rollers 203 of pop-up roller assembly 200. As a result, an IGU is extended outward (e.g., 3-6 inches) from the aligned slot of rack 15. Accordingly, the bottom front edge of the IGU is moved onto horizontal roller 274, and simultaneously, a portion of the front edge of the IGU is captured between paired vertical rollers 282 and 284. Next, laser height sensor 292 detects the height of the IGU so as to locate the top edge of the IGU where the fill hole is located. The detected height provides a Z-axis offset for use by robot 240 to control the Z-axis position of the associated EOATs 250. Thereafter, clamping tool 252 of robot 240 clamps the top of the IGU. In this manner, the IGU is held securely in place during operations carried out by robot 240.

For embodiments of the present invention where automated production system 8 is adapted to perform a gas filling operation, robot 240 first performs the above-described “hole conditioning” with the punching tool, if needed. Thereafter, robot 240 fills the IGU with gas using the gas filling tool, and plugs the fill hole using the hole plugging tool.

Next, robot 240 uses dispensing nozzle tool 262 to patch the IGU by applying butyl sealant over the fill hole, thereby sealing the gas inside the space between the glass panes of the IGU. In this regard, dispensing nozzle tool 262 is moved inward along the edge of the IGU (toward rack 15) from the corner of the IGU, as it dispenses the butyl sealant in the region around the fill hole. This inward movement of dispensing nozzle tool 262 is facilitated by rollers 254 of clamping tool 252 (FIG. 40).

After completion of the sealing process, clamping tool 252 moves to an unclamped position to release the patched IGU, which is then retracted back into rack 150 by control unit 165. In this regard, control unit 165 activates the motorized drive belt system 204 associated with driving horizontal rollers 203 of pop-up roller assembly 200. As a result, the patched IGU is retracted back into a slot of rack 15.

Next, control unit 165 deactivates motorized drive belt system 204, and causes piston/cylinder drive 206 of pop-up roller assembly 200 to return roller unit 202 from the raised position to the lowered position. As roller unit 202 moves to the lowered position, the bottom surface of the IGU is gently placed onto the top surfaces of cross supports 25.

Thereafter, control unit 165 activates motorized sprocket drive assembly 184 to advance rack 15 along the travel path to locate the next slot of rack 15 into alignment with roller guide assembly 270. In this manner, control unit 165 is operable to automatically index each slot of rack 15 to fill and patch a plurality of IGUs loaded on rack 15. Once all the IGUs loaded onto rack 15 have been filled with gas and patched, rack 15 is discharged at exit end 176 of rack indexer assembly 170. A new rack 15 can then be guided onto rack indexer assembly 170 at feed end 174, and the gas fill and seal sequence described above is repeated on additional IGUs.

In accordance with an alternative embodiment of the present invention, fabricating system 220 may be adapted to simultaneously fill and patch multiple IGUs at the same time. It is contemplated that multiple IGUs (e.g., 4 to 8) may be simultaneously extended from rack 15 to undergo gas filling and sealing operations in parallel. For example, in each processing cycle, every 8th IGU loaded onto rack 15 is extended in order to provide sufficient workspace between the multiple IGUs.

In order to operate on multiple IGUs simultaneously, rack indexer assembly 170 includes multiple pop-up roller assemblies 200, fabricating system 220 includes multiple roller guide assemblies 270 to receive IGUs, and robot 240 includes multiple arms 240 with associated EOATs 250. Instead of multiple arms 240, fabricating system 220 may have multiple 6-axis robots 240, each robot 240 adapted to process a different IGU on rack 15.

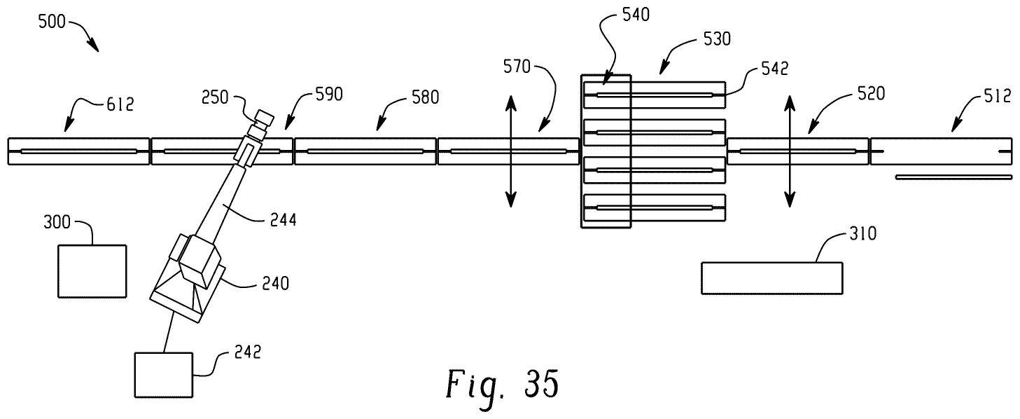

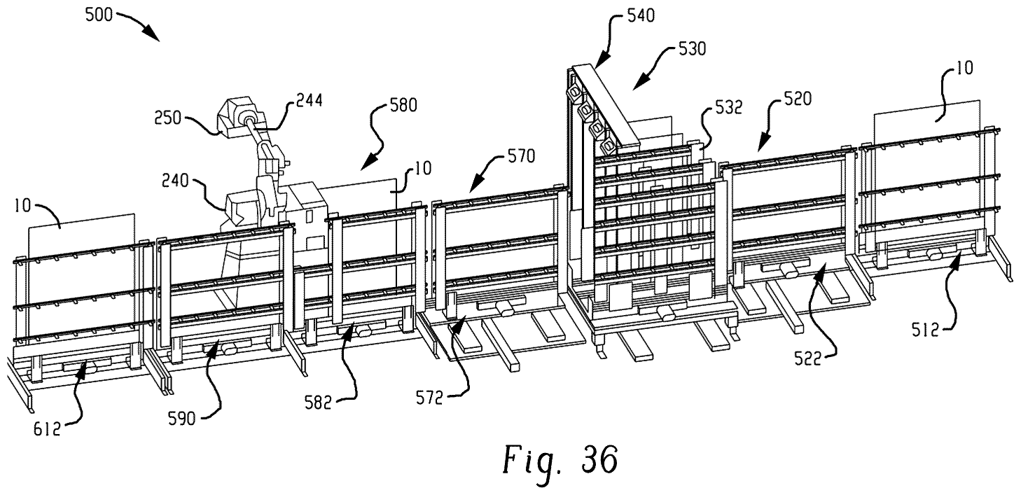

An inline gas filling and patching system 500 according to another embodiment of the present invention will now be described with reference to FIGS. 35-39. Referring now to FIGS. 35 and 36, system 500 is generally comprised of a loading conveyer 512, a loading shuttle 520, a gas filling unit 530 having a plurality of gas filling stations 540, an unloading shuttle 570, a patching unit 580 configure with a single patching station, a buffer conveyer 590, and an unloading conveyer 612. System 500 also includes pump 300 and a control unit 165 housed within a control panel 310. Pump 300 and control unit 165 have been described in detail above.

In the illustrated embodiment, loading conveyer 512 is manually loaded with glass panels 10 by an operator. It is contemplated that in an alternative embodiment, loading conveyer 512 may take the form of automated conveyance system 130 that allows for automatic loading of glass panels 10 onto loading shuttle 520 using rack indexer assembly 170 and rack 15, which are described in detail above.

Loading shuttle 520 includes a moveable platform 522 that supports a pair of spaced vertical support members having a plurality of unpowered and powered rollers. Moveable platform 522 also includes a roller unit comprised of a plurality of motor-driven rollers. The slot between the vertical support members is dimensioned to receive a glass panel 10. A 2-axis (X-Y) servo drive receives a command signal from control unit 165 and transmits electric current to a servo motor to produce motion proportional to the command signal. Servo motor moves platform 522 in a direction generally perpendicular to the direction of the processing line of system 500 to transfer glass panel 10 from loading conveyer 512 to gas filling unit 530, as will be explained in further detail below.

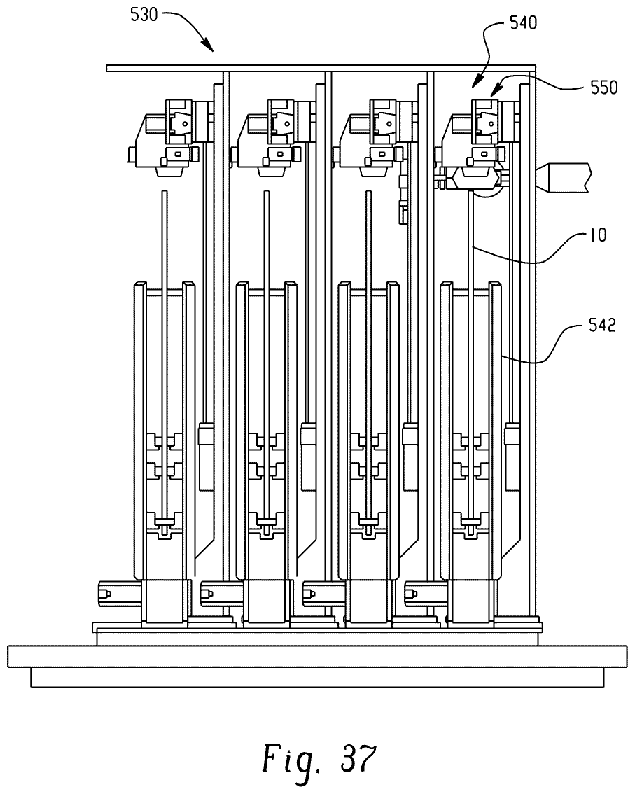

Gas filling unit 530 is generally comprised of one or more gas filling stations 540. Each gas filling station 540 includes a slot 542 for receiving a glass panel 10, and an associated gas filling head 550 for dispensing gas, as best seen in FIGS. 37-39. Each slot 542 is defined by a pair of spaced vertical support members having a plurality of unpowered and powered rollers. A roller unit comprised of a plurality of motor-driven rollers is also located within each slot 542. Slot 542 between the spaced vertical support members is dimensioned to receive a glass panel 10. Each gas filling head 550 is generally comprised of a gas filling probe or nozzle 552, a camera 554 (e.g., an industrial machine vision imaging camera), and a 3-axis (X-Y-Z) servo head. Camera 554 and nozzle 552 are mount to the servo head which operates to adjust the location of camera 554 and gas filling head 550. The 3-axis servo head is comprised of a 3-axis servo drive and associated servo motor.

Nozzle 552 of gas filling head 550 dispenses gas from a gas source (e.g., gas filling machine). Camera 554 of gas filling head 550 is used to determine the location of the gas-filling hole of glass panel 10 for insertion of nozzle 552 into the gas-filling hole. The 3-axis servo head moves nozzle 552 to the location of the gas-filling hole according to image data obtained by camera 554. Control unit 165 communicates with the 3-axis servo head, camera 554, and the gas filling machine (not shown). In the illustrated embodiment, gas filling unit 530 is configured with four (4) gas filling station 540. However, it is contemplated that the present invention may be adapted for any number of desired gas filling stations 540. In some applications, gas filling unit 530 may have only a single gas filling station 540. In such cases, loading shuttle 520 and unloading shuttle 570 can be replaced with a conveyer similar to buffer conveyer 590 (described below) or omitted from inline gas filling and patching system 500.

Unloading shuttle 570 is substantially the same as loading shuttle 520 described above. Loading shuttle 570 includes a moveable platform 572 that supports a pair of spaced vertical support members having a plurality of unpowered and powered rollers. Moveable platform 572 also includes a roller unit comprised of a plurality of motor-driven rollers. The slot between the vertical support members is dimensioned to receive a glass panel 10. A 2-axis (X-Y) servo drive receives a command signal from control unit 165 and transmits electric current to a servo motor to produce motion proportional to the command signal. The servo motor moves platform 572 in a direction generally perpendicular to the direction of the processing line of system 500 to transfer glass panels 10 from a gas filling station 540 to patching unit 580, as will be explained in further detail below.

Patching unit 580 is similar to automated production system 8 for patching glass panels, as described in connection with FIG. 27. In this regard, patching unit 580 of the illustrated embodiment is comprised of a 6-axis robot 240 that is controlled by a robotic controller 242. Robot 240 includes an arm 244 having one or more end-of-arm tools (EOAT) 250 mounted at the distal end thereof. In the illustrated embodiment, EOATs 250 include a pneumatic clamping tool 252 (see FIGS. 40-41) having rollers 254, and a dispensing nozzle tool 262 (see FIGS. 38-39) for dispensing an insulating glass sealant (such as a conventional butyl sealant) to seal glass panel 10. Dispensing nozzle tool 262 is in fluid connection with pump 300 via a hose (not shown) for receiving the sealant. Patching unit 580 also includes a conveyer 582 having a platform that supports a pair of spaced vertical support members having a plurality of unpowered and powered rollers. The platform also includes a roller unit comprised of a plurality of motor-driven rollers. The slot between the vertical support members is dimensioned to receive a glass panel 10. The vertical support members support glass panel 10 while robot 240 patches glass panel 10, thereby sealing gas inside glass panel 10.

In the illustrated embodiment, patching unit 580 is configured with a single patching station for patching only one glass panel 10. However, it is contemplated that the present invention may be adapted for multiple patching stations. In such cases, patching unit 580 is adapted with multiple slots, each slot receiving a single glass panel 10, similar to the multiple slots of gas filling stations 540. Accordingly, patching unit 580 can receive multiple glass panels 10 for patching, where each glass panel 10 is received by the slot of a separate patching station. Furthermore, in this alternative embodiment, buffer conveyer 590 is replaced by an unloading shuttle similar to unloading shuttle 570, which is described above. It is contemplated that a single robot 240 may patch glass panels 10 at multiple patching stations.

Buffer conveyer 590 is substantially the same as conveyer 582 of patching unit 580. In the illustrated embodiment, there is no processing of glass panel 10 at buffer conveyer 590. In this regard, the primary function of buffer conveyer 590 is to space patching station 580 from unloading conveyer 612. It is contemplated that buffer conveyer 590 may be omitted in alternative embodiments of system 500.

Unloading conveyer 612 is substantially the same as loading conveyer 512. In the illustrated embodiment, unloading conveyer 612 takes the form of manual conveyance system 70 where glass panels 10 are manually unloaded by an operator. It is contemplated in an alternative embodiment that unloading conveyer 612 may take the form of automated conveyance system 130 that allows for automatic unloading of glass panels 10 from buffer conveyer 590 using rack indexer assembly 170 and rack 15, which are described in detail above.

It should be understood that control unit 165 is programmed to control operation of loading shuttle 520, gas filling unit 530, unloading shuttle 570, patching unit 580, and buffer conveyer 590. Control unit 165 is programmed to control the movement of shuttles 520 and 570, and to control powered rollers to advance the glass panes 10 through system 500.

Operation of inline gas filling and patching system 500 will now be described according to the illustrated embodiment. First, an operator manually loads a glass panel 10 (e.g., an insulating glass unit (IGU)) onto loading conveyor 512. Next, glass panel 10 is conveyed from loading conveyer 512 to loading shuttle 520. In an alternative embodiment where loading conveyer 512 takes the form of automated conveyance system 130, glass panel 10 may be automatically loaded onto loading shuttle 520 using rack indexer assembly 170 and rack 15.

Loading shuttle 520 moves in the X-direction (i.e., perpendicular to processing line) to align and transfer glass panel 10 into an empty slot 542 of a gas filling station 540. Loading shuttle 520 continues to load glass panels 10 into empty slots 542 as they become available. At each gas filling station 540, camera 554 identifies the location of gas fill hole in glass panel 10 and transfers the location coordinates to the 3-axis servo head to align nozzle 552 with the gas fill hole and insert nozzle 552 into glass panel 10.

Control unit 165 starts a gas filling machine to initiate dispensing of gas into glass panel 10. It should be appreciated that all gas filling heads 550 of gas filling unit 530 may be active simultaneously and independently of each other. Accordingly, multiple glass panels 10 located in the gas filling stations 540 may be filled with gas in simultaneous operations. After a glass panel 10 is filled with the desired quantity of gas, control unit 165 stops the gas filling operation and controls gas filling head 550 to remove nozzle 552 from the glass panel 10.

Next, unloading shuttle 570 is aligned with slot 542 having a glass panel 10 fully filled with gas, and the filled glass panel 10 is transferred from a slot 542 of a gas filling station 540 onto unloading shuttle 570, which moves in the X-direction. Thereafter, unloading shuttle 570 transfers the glass panel 10 onto conveyer 582 of patching unit 580.

Patching unit 580 includes robot 240 having a butyl patching head that patches glass panel 10 by covering the gas-filling hole and any exposed spacer material, thereby creating an air tight seal. As robot 240 of patching station 580 patches the filled glass panel 10, unloading shuttle 570 aligns with the next slot 542 of a gas filling station 540 having a glass panel 10 fully filled with gas, and the filled glass panel 10 is transferred from a slot 542 onto unloading shuttle 570.

When the patching process is completed for the first glass panel 10 at patching unit 580, it is transferred from conveyer 582 to buffer conveyer 590, and subsequently transferred to unloading conveyer 612, where the first glass panel 10 is manually unloaded from unloading conveyer 612 by an operator and placed on a finished goods cart. In an alternative embodiment where loading conveyer 612 takes the form of automated conveyance system 130, glass panel 10 may be automatically unloaded from buffer conveyer 590 using rack indexer assembly 170 and rack 15.

Once the first glass panel 10 is transferred out of conveyer 582 of patching station 580, unloading shuttle 570 transfers the next filled glass panel 10 to conveyer 582 of patching station 580. Thereafter, subsequently filled glass panel 10 will proceed through system 500 in the same manner as the first glass panel 10.

The foregoing describes specific embodiments of the present invention. It should be appreciated that these embodiments are described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

What is claimed is:

1. An automated production system for glass panels, said system comprising:
a rack indexer assembly including a pop-up roller assembly having a roller unit comprised of a plurality of motor-driven rollers, said roller unit movable between a lowered position and a raised position, wherein in the raised position, the plurality of rollers of the roller unit align linearly along a horizontal axis with the plurality of rollers of the support frame;
a glass panel fabricating system including (a) a robot system for gas filling of glass panels and/or (b) a robot system for patching of glass panels; and
a control unit for controlling operation of the glass panel fabricating system and movement of the roller unit between the lowered and raised positions.

2. A method for producing glass panels, comprising:
loading a plurality of glass panels onto a rack;
moving the rack along a travel path to a first position using an automated rack indexing assembly, said travel path associated with the processing equipment for a glass panel production line;
extending a first glass panel outward from the rack for processing;
retracting the first glass panel into the racking after processing;
moving the rack along the travel path to a second position using the automated rack indexing assembly; and
extending a second glass panel outward from the rack for processing; and
retracting the second glass panel into the racking after processing.

3. The method according to claim 2, wherein the method further comprises:
clamping said first and second glass panels when extended outward from the rack for processing.

4. The method according to claim 2, wherein the method further comprises:
unloading the first and second glass panels from the rack.

5. The method according to claim 2, wherein said processing includes at least one of:
filling the glass panel with gas, and
patching a fill hole of the glass panel.

6. A gas filling and patching system for processing glass panels, comprising:
a gas filling unit having one or more gas filling stations for filling glass panels with gas;
a patching unit having one or more patching stations for patching glass panels filled with gas;
a loading shuttle for conveying a glass panel to the gas filling unit; and
an unloading shuttle for unloading the glass panel filled with gas from the gas filling unit and conveying the glass panel to the patching unit.

7. The gas filling and patching system of claim 6, further comprising:
a loading conveyer for conveying the glass panel to the loading shuttle.

8. The gas filling and patching system of claim 6, further comprising:
a buffer conveyer for conveying glass panels between the patching unit and an unloading conveyer.

9. The gas filling and patching system of claim 6, wherein the gas filling unit has a plurality of gas filling stations to simultaneously fill a plurality of glass panels with gas.

10. The gas filling and patching system of claim 6, wherein the patching unit has a plurality of patching to simultaneously patch a plurality of glass panels.

11. The gas filling and patching system of claim 6, wherein each gas filling unit includes a camera for identifying the location of a gas fill hole in the glass panel.

12. The gas filling and patching system of claim 6, wherein the patching unit comprises a having a butyl patching head.

13. A method for gas filling and patching of glass panels, the method comprising:
conveying a glass panel to a loading shuttle;
moving the loading shuttle to align and transfer the glass panel to a gas filling unit, said gas filling unit having one or more gas filling stations, each gas filling station having a slot for receiving a glass panel;
moving the loading shuttle to continue loading glass panels into empty slots of the gas filling unit;
simultaneously and independently filling each glass panel in the slots of the gas filling stations with gas;
after a gas filling operation is completed for a glass panel, conveying the glass panel from the slot of the gas filling station to unloading shuttle;
conveying the glass panel from the unloading shuttle to a patching unit for pathing the glass panel; and
transferring the patched glass panel out of the patching unit.

14. The method for gas filling and patching of claim 13, wherein the glass panel is loaded onto the loading shuttle from a loading conveyer, said loading conveyer manually loaded with the glass panel.

15. The method for gas filling and patching of claim 13, wherein the glass panel is automatically loaded onto the loading shuttle.
